(19) United States
(12) Patent Application Publication
(10) Pub. No.: US 2025/0252079 A1
(43) Pub. Date: Aug. 7, 2025

(54) APPARATUSES, COMPUTER-IMPLEMENTED METHODS, AND COMPUTER PROGRAM PRODUCTS FOR TARGETED FILE SCANNING OF LARGE DATA SYSTEMS

(71) Applicant: Wells Fargo Bank, N.A., San Francisco, CA (US)

(72) Inventors: Deepa GHOSH, Charlotte, NC (US); Lisa M. LEE, Salt Lake, UT (US); Jamie KENNEDY, Charlotte, NC (US)

(21) Appl. No.: 17/224,366

(22) Filed: Apr. 7, 2021

(51) Int. Cl. G06F 16/14; G06F 11/34; G06F 16/182

(52) U.S. Cl. CPC G06F 16/148; G06F 11/3476; G06F 16/182

(57) ABSTRACT

Embodiments of the present disclosure enable improved methodologies of scanning files for target files, for example EUCTs, in large, complex data systems. Embodiments of the present disclosure sufficiently narrow the population of candidate files to a reduced candidate file set that narrowly targets candidate files in a manner that enables processing of such significant candidate files while remaining accurate and efficient. Embodiments reduce the amount of manual effort that may be involved in scanning for target files in file repositories of a data system. Example embodiments identify a plurality of candidate data files associated with one or more file repositories, determine, from the plurality of candidate files, a reduced set of candidate data files, wherein the reduced set of candidate data files are determined by applying a hierarchy of scan criteria to the plurality of candidate data files, and output the reduced set of candidate data files.

### TECHNOLOGICAL FIELD

Embodiments of the present disclosure generally relate to improved scanning for target files in a large data system, such as scanning for end-user computing tools (EUCTs), and specifically to methodologies for efficiently and accurately scanning to identify target files of a particular classification, such as EUCTs, in large data system comprising a significant number of files for scanning (e.g., hundreds, thousands, millions, billions, or more files).

### BACKGROUND

Scanning for a particular target files of a particular classification in a large data system is often cumbersome and/or prohibitively time consuming. In one such example context of scanning for specific target files, EUCTs often pose a risk to data processes and data security of systems within which the EUCTs are utilized. A type of target file, such as EUCTs, may be monitored to ensure that as complete an inventory of these files is maintained, for example such that all EUCTs may be governed by particular policies that minimize the risk of data security issues arising from use of such EUCTs. Applicant has discovered problems with current implementations of identifying target files (e.g., EUCTs) in a large data system comprising a significant number of files. Through applied effort, ingenuity, and innovation, Applicant has solved many of these identified problems by developing embodied in the present disclosure, which are described in detail below.

### BRIEF SUMMARY

In general, embodiments of the present disclosure provided herein enable efficient, yet still sufficiently accurate scanning to identify target files, for example EUCTs, in large data system (e.g., systems having one or more repositories hosting a number of data files that would be computationally impossible to process efficiently and accurately utilizing conventional methodologies, such as hundreds of millions, billions, or more of such data files). Other implementations for improved scanning for target files in a large data system will be, or will become, apparent to one with skill in the art upon examination of the following figures and detailed description. It is intended that all such additional implementations be included within this description be within the scope of the disclosure, and be protected by the following claims.

In accordance with one aspect of the present disclosure, a computer-implemented method for improved scanning for target files is provided. The computer-implemented method may be implemented by one or more computing devices embodied in hardware, software, firmware, and/or any combination thereof, as described herein. In one example embodiment, the example computer-implemented method includes identifying a plurality of candidate data files associated with one or more file repositories. The example computer-implemented method further includes determining, from the plurality of candidate files, a reduced set of candidate data files, each candidate data file of the reduced set of candidate data files determined as a possible EUCT, where determining the reduced set of candidate data files comprises applying a hierarchy of scan criteria to the plurality of candidate data files. The example computer-implemented method further includes outputting the reduced set of candidate data files.

Additionally or alternatively, in some embodiments of the example computer-implemented method, the computer-implemented method further includes generating, for each candidate data file in the reduced set of candidate data files, a target likelihood score that represents a probability the candidate data file is an end-user computing tool based on one or more data properties associated with the candidate data file; determining the reduced set of candidate data files comprises at least one high target probability file based on at least the target likelihood score for each candidate data file in the reduced set of candidate data files; and assigning, in response to the determination, each of the at least one high target probability file to a target file review user account.

Additionally or alternatively, in some embodiments of the example computer-implemented method, the computer-implemented method further includes applying a first scan criteria to the plurality of candidate data files to determine a preliminary reduced set of candidate data files from the plurality of candidate data files; and applying a second scan criteria to the preliminary reduced set of candidate data files to determine the reduced set of candidate data files.

Additionally or alternatively, in some embodiments of the example computer-implemented method, applying the hierarchy of scan criteria to the plurality of candidate files comprises applying each scan criteria of the hierarchy of scan criteria iteratively to determine the reduced set of candidate data files.

Additionally or alternatively, in some embodiments of the example computer-implemented method, the hierarchy of scan criteria comprises one or more of: a timeliness of file factor; a type of file factor; a calculations user factor; a keyword factor; and/or an owner role factor.

Additionally or alternatively, in some embodiments of the example computer-implemented method, the one or more file repositories comprises a plurality of shared file repositories, each shared file repository of the plurality of shared file repositories separate from the other shared file repositories of the plurality of shared file repositories.

Additionally or alternatively, in some embodiments of the example computer-implemented method, the computer-implemented method further includes causing rendering of a scan configuration interface that comprises at least one hierarchy configuration element configured to, upon user interaction, configure at least a portion of the hierarchy of scan criteria

Additionally or alternatively, in some embodiments of the example computer-implemented method, the computer-implemented method further includes causing rendering of a scan configuration interface that comprises at least one scan target configuration element configured to, upon user interaction, select the one or more file repositories from a data system associated with the one or more file repositories.

In accordance with a second aspect of the present disclosure, an apparatus for improved scanning for target files is provided. In an example embodiment, the example apparatus includes at least one processor and at least one memory. The at least one memory stores computer-coded instructions thereon that, in execution with the at least one processor are configured to perform any one of the example computer-implemented methods described herein. In yet another example embodiment apparatus, the example apparatus includes means for performing each step of any one of the example computer-implemented methods described herein.

In accordance with a third aspect of the present disclosure, a computer program product for improved scanning for target files is provided. In accordance with an example embodiments, the example computer program product includes at least one non-transitory computer-readable storage medium having computer program code stored thereon configured, in execution with at least one processor, for performing any one of the example computer-implemented methods described herein.

In accordance with yet another aspect of the present disclosure, a computer-implemented method for EUCT alerting is provided. The computer-implemented method may be implemented by one or more computing devices embodied in hardware, software, firmware, and/or any combination thereof, as described herein. In a second example embodiment, the second example computer-implemented method includes detecting a file storage event initiated via a EUCT-monitored executable object, the file storage event associated with a modified data file. The second example computer-implemented method further includes scanning file content data of the modified data file to identify whether at least one calculation subprocess exists in the file content data. The second example computer-implemented method further includes, in response to identifying the file content data comprises the at least one calculation subprocess, generating an EUCT creation alert; and causing rendering of the EUCT creation alert to a client device.

Additionally or alternatively, in some embodiments of the second computer-implemented method, the second computer-implemented method further includes detecting initiation of termination of the EUCT-monitored executable object, where the computer-implemented method comprises generating the EUCT creation alert and causing rendering of the EUCT creation alert to the client device in response to detecting initiation of termination of the EUCT-monitored executable object.

Additionally or alternatively, in some embodiments of the second computer-implemented method, the file storage event comprises a new file saving event.

Additionally or alternatively, in some embodiments of the second computer-implemented method, the file storage event comprises a file modification event.

Additionally or alternatively, in some embodiments of the second computer-implemented method, the EUCT-monitored executable object comprises an EUCT monitoring sub-executable object incorporated into the EUCT-monitored executable object, and where the computer-implemented method comprises detecting the file storage event via the EUCT monitoring sub-executable object, the computer-implemented method comprises scanning the file content data via the EUCT monitoring sub-executable object, the computer-implemented method comprises generating the EUCT creation alert via the EUCT monitoring sub-executable object, and the computer-implemented method comprises causing rendering of the EUCT creation alert to the client device via the EUCT monitoring sub-executable object.

Additionally or alternatively, in some embodiments of the second computer-implemented method, the EUCT-monitored executable object is executed on the client device, and where the EUCT-monitored executable object is pre-configured incorporating the EUCT monitoring sub-executable object.

Additionally or alternatively, in some embodiments of the second computer-implemented method, the EUCT creation alert is generated comprising data indicating existence of one or more data portions indicating the modified data file embodies an EUCT, the one or more data portions including data indicating existence of the at least one calculation.

Additionally or alternatively, in some embodiments of the second computer-implemented method, the EUCT creation alert including data indicating retention policy information associated with maintenance of the modified data file.

In accordance with a yet another aspect of the present disclosure, an apparatus for EUCT alerting is provided. In an example embodiment, the example apparatus includes at least one processor and at least one memory. The at least one memory stores computer-coded instructions thereon that, in execution with the at least one processor are configured to perform any one of the second example computer-implemented methods described herein. In yet another example embodiment apparatus, the example apparatus includes means for performing each step of any one of the second example computer-implemented methods described herein.

In accordance with yet another of the present disclosure, a computer program product for improved scanning for EUCT alerting. In accordance with an example embodiments, the example computer program product includes at least one non-transitory computer-readable storage medium having computer program code stored thereon configured, in execution with at least one processor, for performing any one of the second example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system for improved target file scanning that may be specially configured within which embodiments of the present disclosure may operate;

FIG. 2A illustrates a block diagram of an example targeted file scanning apparatus that may be specially configured in accordance with an example embodiment of the present disclosure;

FIG. 2B illustrates a block diagram of an example EUCT alerting user apparatus that may be specially configured in accordance with an example embodiment of the present disclosure;

FIG. 3 illustrates a block diagram of an example data system that may include stored EUCT files in accordance with at least some example embodiments of the present disclosure;

FIG. 4 illustrates a visualization of an example hierarchy of scan criteria in accordance with at least some example embodiments of the present disclosure;

FIG. 5 illustrates a table of keyword extracted from definition criteria and associated occurrences in known EUCTs for use in keyword mining based on keyword criteria for EUCT identification in accordance with at least some example embodiments of the present disclosure;

FIG. 6 illustrates a table of keywords extracted from restricted data for use in keyword mining based on keyword criteria for EUCT identification in accordance with at least some example embodiments of the present disclosure;

FIG. 7 illustrates a table of keywords extracted from EUCT information for use in keyword mining based on keyword criteria for EUCT identification in accordance with at least some example embodiments of the present disclosure;

FIG. 8 illustrates a flowchart depicting example operations of a process for scanning a system of files for EUCT in accordance with some example embodiments of the present disclosure;

FIG. 9 illustrates a flowchart depicting example additional operations of a process for scanning a system of files for EUCT, specifically for causing rendering of particular scan configuration interfaces in accordance with at least some example embodiments of the present disclosure;

FIG. 10 illustrates a flowchart depicting example additional operations of a process for scanning a system of files for EUCT, specifically for applying a plurality of scan criteria in accordance with at least some example embodiments of the present disclosure;

FIG. 11 illustrates a visualization of interactions between computing components in an example computing environment for EUCT alerting in accordance with at least some example embodiments of the present disclosure;

FIG. 12 illustrates a visualization of data interactions between computing components in an example computing environment for EUCT alerting in accordance with at least some example embodiments of the present disclosure;

FIG. 13 illustrates an example user interface representing an EUCT creation alert in accordance with at least some example embodiments of the present disclosure; and

FIG. 14 illustrates a flowchart depicting example operations of a process for EUCT alerting in accordance with at least some example embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

EUCTs pose a myriad of risks to operations of a particular system and business associated with such systems. For example, EUCTs pose reputational and financial risk, risks of fraud, data security risks, and the like if such EUCTs are not maintained, tracked, and/or utilized appropriately. To mitigate such risks, an enterprise often enforces particular governance and/or policies with respect to maintaining and/or utilizing EUCTs. However, as EUCTs are regularly created, updated, and/or utilized from computing tools readily accessible to one or more users, consistent identification and/or tracking of such EUCTs is desirable to ensure that all instances of EUCTs are being governed appropriately.

Conventional implementations utilize manual identification of possible, candidate files to determine whether the file should be scanned as embodying or comprising a target file, such as an EUCT. Such methodologies, however, are inefficient, and quickly become impossible to keep up with in a circumstance where even a relatively small number of files is/are consistently accessed, updated, created, and/or the like. Alternative conventional implementations suggest rudimentary scanning implementations to attempt to identify target files, such as EUCTs, such as by performing a detailed scan of all relevant data properties for each candidate file in a large data system. These rudimentary scanning implementations, however, similarly face a plurality of technical challenges.

In various circumstances, computing systems have grown such that a significant number of data files are stored at a given time. For example, in the context of a computing system supporting a large-scale bank, the computing system may include hundreds of millions, billions, or more of data files. Such data files may be arranged into a plurality of different repositories, sub-repositories or folders within such repositories, and/or the like. In this regard, the scale and complexity of such systems makes robust searching of the entirety of the system computationally impossible. For example, in circumstances where all files were to be scanned for possible EUCT, such scanning would take an entirely impractical amount of time, or in some circumstances never complete (e.g., scan for decades or longer).

Such rudimentary scanning implementations fail to sufficiently address the scale and complexity of large data systems, leaving the scanning population too large to practically scan. For example, some industry standard implementations scan files modified in the last 18 months without applying additional analytics, which for a significantly sized large data system may still include a number of files that remains computationally impractical or impossible to compute (e.g., hundreds of millions of files, billions of files, or more). Such conventional implementations fail to function for such large data systems, leaving no practical option for effectively and efficiently performing scanning for particular target files in the large data system based on existing methodologies.

Embodiments of the present disclosure provide for improved scanning for target files, such as EUCTs. In this regard, embodiments of the present disclosure provide methodologies for scanning all data systems (including large data systems having sufficient data files to be previously impossible to scan effectively utilizing conventional implementations). Embodiments of the present disclosure focus on particular scan criteria that enables identification of particular locations for scanning. By focusing on a limited number of storage locations and file characteristics such as age, file type as identified via the scan criteria, for example, such embodiments reduce the overall population of scanned data files in large data systems to a number that remains practical for more detailed scanning. Such embodiments reduce the population of target files for scanning to merely a percentage of the total population of files on the system (e.g., 8% or lower of the total population of data files, for example) to improve the overall processing time associated with such scanning significantly. The improvement in processing time and saved computing resources provided by embodiments of the present disclosure may be significant, for example by orders of magnitude greater than conventional scanning alone.

Embodiments of the present disclosure provide various technical improvements in the field of target file identification and scanning. Whether manual or automatic via a computing system, conventional file scanning implementations failed to provide a methodology that would be usable for large and/or complex data systems. Embodiments of the present disclosure address this technical problem by limiting the population size of candidate data files utilizing various particular scan criteria described herein. Additionally or alternatively, by reducing the overall population to particular locations of candidate files for scanning, embodiments of the present disclosure reduce the amount of computing resources and computing time required to complete a scanning operation regardless of size of the data system. The various embodiments provide such technical improvements while maintaining accuracy with respect to such scanning operations, such that a majority or all of the EUCTs that would otherwise be caught in conventional scans are similarly scanned in accordance with the embodiments herein.

In an example context, embodiments of the present disclosure are utilized in scanning various file repositories of a data system for identifying target files, such as EUCTs, stored on the file repositories. For example, the file repositories of the data system may embody a number of shared file repositories (e.g., shared drives) accessible to various users and/or computing devices of different business units of a particular business entity. The shared file repositories may include a significant number of files, such that conventional scanning of such files is computationally impractical as described.

Candidate files may embody the files stored on the shared file repositories may define a plurality of files that are candidates for a detailed scan to determine if the file is a target file (e.g., an EUCT). Embodiments of the present disclosure may narrow the overall population of candidate files for scanning to a significantly reduced set of candidate files. For example, a plurality of scan criteria may be applied to the various candidate files to determine whether the candidate files should be excluded from consideration for scanning. Upon applying the plurality of scan criteria, as described herein, the resulting set of candidate files may represent those candidate files that are associated with values for certain data properties that indicate the candidate file may, or is likely to, include or embody a target file, such as an EUCT.

By narrowing the full plurality of candidate files to a significantly reduced set of candidate files, the amount of time and processing resources that are required for scanning the remaining reduced set of candidate files is significantly reduced as compared to that for scanning the full plurality of candidate files. Additionally, the particular scan criteria may be specially configured to ensure the accuracy of such excluded candidate files are maintained. In this regard, the scan criteria may, in some contexts, be determined and/or configured based on known information regarding the existence of what data values define a particular target file,, such as based on what particular file types can or are likely to embody or include a target file, how often files embodying or including a target file are accessed, which user roles and/or users are likely to create or otherwise engage with files embodying or including a target file, and/or the like. In this regard, the scan criteria and application of such scan criteria as described herein provides improvements to utilization of processing resources while maintaining a high accuracy of excluding candidate files as possibly a target file. In other words, embodiments of the present disclosure accurately exclude enough candidate files to enable detailed scanning of the remaining candidate files to be computationally efficient without sacrificing significant accuracy in identifying which candidate files may embody or include a target file. The remaining candidate files may subsequently be scanned utilizing a more detailed scan to determine whether the candidate file embodies or include a target file.

For ease of description and understanding, aspects of the present disclosure are described with respect to scanning for target files embodying EUCT. It should be appreciated, in accordance with the disclosure herein, that in other embodiments target files may embody an alternative conceptual categorization of files. For example, in other embodiments, the scanning methodologies described herein may be performed to identify other high-risk files in one or more data repositories based on particularly defined scan criteria. In this regard, the description provided herein with respect to EUCTs specifically should not limit the scope and spirit of the disclosure.

Additionally or alternatively, some embodiments of the present disclosure are provided for EUCT alerting. In this regard, the risk of EUCTs to system and business operations has been established. Often, users do not realize or appreciate when they have created an EUCT, nor the ramifications of such actions. Additionally, conventional systems for accessing and modifying data files lack sufficient tools for indicating to a user when a file embodying or likely embodying an EUCT has been stored by the user.

Various embodiments of the present disclosure provide for EUCT alerting at the time a data file determined to embody or possibly embody an EUCT has been stored. In this regard, such embodiments may provide an EUCT creation alert to a user to sufficiently make the user aware of the ramifications associated therewith in response to the newly stored data file. By providing alert(s) in real-time at the time of storage, immediate action may be taken to ensure the data file is stored in a manner appropriate to mitigate the EUCT risk to the system and business operations. Additionally, in some embodiments, by implementing such functionality via an incorporated computing tool (e.g., a plugin or other sub-executable process or application that extends functionality of a client-side application), such alerting may be performed even in circumstances where a computing device is utilized to create and store a data file embodying or likely embodying an EUCT regardless of whether the computing device is connected to a centralized network that may otherwise perform such verification and/or alerting for new files.

### Definitions

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

The term “set” with respect to a particular type of data (e.g., a “set of data X” or a “data X set”) refers to one or more data objects embodying or including any number of instances of the particular data set. For example, as described herein, a set of candidate data files may include any number of candidate data objects, a set of scan criteria may include any number of individual scan criteria and the like.

The term “target file” refers to electronically managed data embodying a file associated with particular properties to be identified from a candidate file set via one or more processes associated with scanning the candidate file set. A target file embodies a data-driven determination characterizing the file and/or the properties associated with the file. For example, in one example context, a target file refers to a characterization of files to be searched for in a candidate file set, for example files embodying EUCTs.

The terms “end-user computing tool” and “EUCT” refer to a file embodying a computing tool accessible to an end user that transforms input data to produce output data and is not supported by standard software development and/or software control process(es) associated with computing tool distribution and/or use. An EUCT is created utilizing an existing computing tool (e.g., a software application supported by standard development and/or software control process(es) associated with computing tool distribution and/or use). In some embodiments, an EUCT is not supported by the same control environment for distribution of formally developed or obtained (e.g., purchased) software application(s). It should be appreciated that a particular system, user, or other entity (e.g., a business entity) may provide a particular definition for an EUCT based on particular data properties, creation methodologies, storage methodologies, and/or the like. In some embodiments, an EUCT embodies a model or software application program designed and/or otherwise configured to operate via an existing software program that provides end-user-level access to formula creation, model creation, and/or software programming. Non-limiting examples of EUCT include specially programmed Microsoft Access files, custom calculation spreadsheets made in Microsoft Excel, one or more process(es) implemented by an end user via at least one software programming language, and the like.

The term “data system” refers to one or more computing devices embodied in hardware, software, firmware, and/or a combination thereof, that includes one or more data repositories accessible via client devices included in or that communicate with such computing devices. In some embodiments, file repositories of a particular system are interconnected such that client devices accessing the data system have access to some or all of the file repositories embodying part of the data system.

The term “file repository” refers to a specially configured database, memory, and/or other storage space embodied in hardware, software, firmware, and/or a combination thereof, that stores one or more files. Non-limiting examples of a file repository include a specially configured generic server device, database server, virtual server, cloud server, and a memory device local or connected to a client device.

The term “shared file repository” refers to a file repository accessible by various users corresponding to client device(s) interacting with or within a particular data system. In some such embodiments, all client devices having access to a shared file repository may be associated with particular permissions indicating whether each client device may read files stored to the shared file repository, and/or write files to the shared file repository. In some embodiments, a shared file repository is accessible to various client devices over one or more communications networks.

The term “candidate data file” refers to electronically managed data embodying a file stored to at least one file repository that is to be processed to determine whether the file is likely to embody or include a target file, or is not likely to embody or include a target file. Candidate data files identified as likely to embody or include a target file may be processed via a more detailed scanning operation to determine whether the candidate data file in fact embodies or includes a target file. Such a more detailed scanning operation does not consider (e.g., skips or otherwise is not performed for) candidate data files identified as not likely to embody or include a target file. In some embodiments, candidate data files are eliminated from consideration associated with a particular detailed scan for target files based on particular scan criteria and value(s) for any number of data properties associated with the candidate data file, as described herein.

The term “data property” with respect to a candidate data file refers to a particular portion of metadata associated with the candidate data file or a particular portion of the content of a candidate data file. Each data property for a candidate data file may be associated with a particular data value, which may differ for each candidate data file depending on the metadata and/or data of the candidate data file. Non-limiting examples of a data property include a filename, a file type, a file content length, a file size, a file content title, a file author, a last-accessed datetime, a file created datetime, a file storage location, and file permissions data.

The term “reduced set of candidate data files” refers to a set of candidate data files with one or more candidate data files excluded based on a determination that such data files are not likely to embody or otherwise include a target file.

The term “scan criteria” refers to a comparison, model, or algorithm that indicates a likelihood of a particular candidate data file or a particular set of candidate data files being based on data value(s) for one or more data properties associated with the scan criteria. In some embodiments, a target likelihood score is determined based on one or more scan criteria. Additionally or alternatively, in some embodiments, an individual scan criteria determines whether a candidate data file should be determined as likely to include or embody a target file.

The term “timeliness of file factor” refers to a particular scan criteria that indicates whether a candidate data file is likely to include or embody target file based on the age of the candidate data file and/or time since the candidate file has been accessed and/or modified.

The term “type of file factor” refers to a particular scan criteria that indicates whether a candidate data file is likely to include or embody target file based on the file type associated with the candidate file.

The term “calculations user factor” refers to a particular scan criteria that indicates whether a candidate data file is likely to include or embody a target file based on whether a calculation operation or other calculation performance data is determined to be present within the candidate data file.

The term “keyword factor” refers to a particular scan criteria that indicates whether a candidate data file is likely to include or embody a target file based on whether the candidate data file includes one or more instances of a particular keyword in particular portions of the candidate data file (e.g., in the content of the candidate file) or all portions of the candidate file (e.g., in the filename, and/or the like).

The term “owner role factor” refers to a particular scan criteria that indicates whether a candidate data file is likely to include or embody a target file based on a determined system or entity role assigned for an owner or creator of the candidate file.

The term “hierarchy of scan criteria” refers to an organization or other ordering of a plurality of scan criteria such that scan criteria that are first in the order are utilized to eliminate particular candidate files first and/or are weighted more heavily in determining whether a candidate file is likely to include or embody a target file.

The term “target likelihood score” refers to electronically managed data that represents a probability a candidate data file is target file based on the various data and/or metadata properties associated with the candidate data file. In some embodiments, a target likelihood score is determined based on values for one or more scan criteria.

The term “high target probability file” refers to a candidate data file associated with a target likelihood score determined to indicate the candidate data file is likely to include or embody a target file.

The term “target file review user account” refers to electronically managed data representing a particular user permissioned for or otherwise having access to functionality for manually indicating whether a candidate data file comprises or otherwise embodies a target file.

The term “scan configuration interface” refers to a specially configured user interface that, in response to user interaction with the scan configuration interface or sub-elements thereof, enables configuration of one or more aspects of a scan for target file(s) to be performed. In some embodiments, a scan configuration interface enables selection of and/or updating of scan criteria to utilize for scanning for target file(s) and/or a hierarchy of such scan criteria for scanning for target file(s). Additionally or alternatively, in some embodiments, a scan configuration interface enables selection of particular data repositories of an example data system to scan for target file(s).

The term “output” with respect to particular data refers to transmission of the data to another system, device, sub-system, or other software application for processing. In some embodiments, “output” of data refers to transmission of the data for rendering via a user interface to one or more displays of a particular computing device.

The term “EUCT-monitored executable object” refers to electronically managed data embodying a software application or process executable on one or more computing devices that creates, modifies, and/or stores data files that may embody an EUCT. In some embodiments, the EUCT-monitored executable object is configurable to incorporate an EUCT monitoring sub-executable object.

The term “EUCT monitoring sub-executable object” refers to a second executable software application or process configured to detect attempted storage of a data file via a corresponding EUCT-monitored executable object, and initiate one or more processes in response to such a determination. In some embodiments, an EUCT monitoring sub-executable object is incorporated into an EUCT-monitored executable object, such that the EUCT monitoring sub-executable object adds such EUCT alerting functionality to the operation of the EUCT-monitored executable object. Non-limiting examples of an EUCT monitoring sub-executable object include a plugin, add-in, secondary software process, and linked executable.

The term “termination” with respect to executable objects refers to electronic data signals indicating an initiated process to cease operation of the executable object for any reason. Non-limiting examples of termination of an executable object includes user input initiating closing an EUCT-monitored executable object and shutoff of a client device executing an EUCT-monitored executable object.

The term “file storage event” refers to electronic data signals initiated via an executable object representing a user request to store new data embodying a data file to at least one file repository. In some embodiments, a file storage event is initiated utilizing the “save as” functionality implemented via the executable object. Non-limiting examples of a file storage event include a “new file saving event” and a “file modification event.” The term “new file saving event” refers to a file storage event specifically for storing a new data file to a file repository that was not previously stored to the file repository. The term “file modification event” refers to a file storage event specifically for storing data embodying an updated version of a data file already existing in a file repository.

The term “modified data file” refers to electronically managed data embodying a data file to be stored via a file storage event. It should be appreciated that the modified data file may embody an entirely new data file or a modified version of an existing data file.

The term “file content data” refers to electronically managed data a portion of a data file that is modifiable by a user via functionality provided by an EUCT-monitored executable object. Non-limiting examples of file content data include text and/or image data in a word processor application, cell data in a spreadsheet management application, and database processing queries in a database management application.

The term “calculation subprocess” refers to electronically managed data in file content data of a data file that a user may initiate to manipulate one or more inputs and generate a corresponding output. In some embodiments, a calculation subprocess may be initiated from within an EUCT-monitored executable object by utilizing the EUCT-monitored executable object to access the data file including the calculation subprocess.

The term “EUCT creation alert” refers to electronically managed data that may be provided via a client device to indicate to the user of the client device that a particular data file likely embodies an EUCT. Non-limiting examples of an EUCT creation alert includes renderable text data, a renderable user interface, a push notification, an email message, and/or a real-time rendered pop-up interface.

The term “retention policy information” with respect to a data file refers to electronically managed data representing automatically initiated and/or manually initiated rules for storage and/or use of the data file within a file repository. A particular data file may be stored until one or more criteria embodied in the retention policy information is/are satisfied.

### Example Systems and Apparatuses of the Disclosure

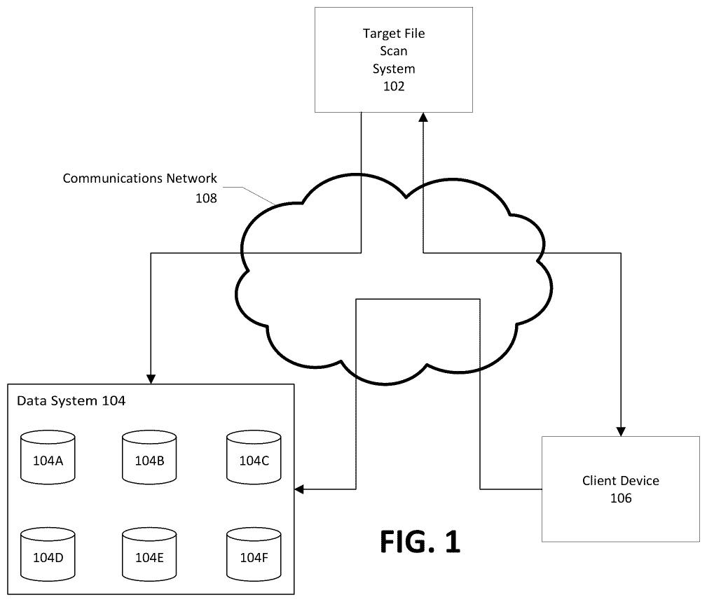

FIG. 1 illustrates a block diagram of a system for improved target file scanning that may be specially configured within which embodiments of the present disclosure may operate. As illustrated, the system for improved target file scanning includes an target file scan system 102, a data system 104, and a client device 106. Additionally or alternatively, in some embodiments, the target file scan system 102, data system 104, and client device 106 communicate over one or more communication network(s), such as the communications network 108 as depicted and described herein. In this regard, the various devices and systems depicted and described with respect to FIG. 1 may communicate to provide the improved target file scanning functionality described herein.

Client device 106 includes one or more computing devices embodied in hardware, software, firmware, and/or the like, or a combination thereof, accessible to a user for accessing particular functionality provided by the data system 104 and/or the target file scan system 102 alone or in conjunction with the other devices and/or systems depicted and described. In some embodiments, the client device 106 comprises an edge terminal (e.g., a user's workstation, personal computer, mobile device, and/or the like) that is configured to communicate with the data system 104 via a particular network. Alternatively or additionally, in some embodiments, the client device 106 is a part of the data system 104. Non-limiting examples of a client device 106 include a smartphone, a mobile device, a personal computer, an enterprise terminal, and/or the like, that utilize a specially configured software application to perform the improved target file scanning functionality described herein. In some embodiments, the client device 106 is specially configured to execute a user-facing application that provides access to such functionality natively and/or via any number of application programming interface (API) calls or other request transmissions to one or more external systems, such as the target file scan system 102 and/or data system 104.

Data system 104 includes one or more computing devices embodied in hardware, software, firmware, and/or the like, or a combination thereof, that is configured to at least store files in one or more file repositories for access by one or more users via corresponding client device(s). In some embodiments, the data system 104 is specially configured to provide additional functionality separate to the storage and/or maintenance of files on one or more data repositories. For example, in some embodiments, the data system 104 additionally includes one or more application servers, specially configured computing devices that perform particular processing functionality, and/or the like.

As illustrated, the data system 104 includes a plurality of file repositories 104A-104F. Each of the file repositories may be specially configured to store any number of files and/or other data. For example, in some embodiments, each of the file repositories 104A-104F embodies a separate virtual or physical memory space that defines the location to which such files are to be stored.

Each file repository 104A-104F may include any number of sub-repositories, folders, and/or the like that further defines the structure of stored data within the file repository. For example, in some embodiments, a file repository may be specially configured to define a particular file system that organizes stored files in particular locations. In some embodiments, one or more users (e.g., administrators or in some embodiments other users) may alter the configuration of one or more file repository and/or the file system defined therein.

Additionally or alternatively, in some embodiments, the data system 104 includes one or more shared file repositories. In this regard, the files saved to the shared file repository may be accessible to all client devices authorized for communication with the data system 104 and/or the particular shared file repository. In this regard, for example, in an instance where a user utilizing the client device 106 has access to the shared file repository, the user may files from the shared file repository to access them and/or write files to the shared file repository. In an example context, for example, the file repositories 104A, 104B, 104C, 104D, and 104E may each represent shared file repositories for use by different users and/or business units of an entity. In this regard, users that authenticate themselves via their corresponding client device 106 as associated with a particular business unit. In some such embodiments, the user may utilize the client device 106 to access the files located on the shared file repository associated with their particular business unit, and/or access shared file repositories for business units associated with the business unit to which the user is a member. In this regard, it should be appreciated that the user of the client device 106 may interact with the data system 104 to perform any number of actions associated with functionality provided by the data system 104 and/or to access and/or utilize files stored to one or more of the file repositories 104A-104F.

The target file scan system 102 includes one or more specially configured computing devices configured in hardware, software, firmware, and/or the like, or a combination thereof, to initiate and/or perform various operations associated with the improved target file scanning functionality described herein. For example, in some embodiments, the target file scan system 102 communicates with the data system 104 to enable identification of candidate files for determining as not likely to include or embody a target file, or for scanning as a possible target file, for example as an EUCT. In this regard, the target file scan system 102 may include any number of database servers, application servers, personal computing devices, networking devices, and/or the like that are specially configured to perform the functionality described herein.

In some embodiments, the target file scan system 102 is communicable with the client device 106 to enable a user of the client device 106 to initiate a scan of the data system 104 to identify possible target files such as EUCTs via the client device 106. For example, in some embodiments, the user of the client device 106 initiates a client-facing application that enables access to one or more user interfaces for initiating such functionality. Additionally or alternatively, in some embodiments, the target file scan system 102 includes one or more computing devices (e.g., application servers and/or corresponding database servers, and/or the like) that access the data system 104 to identify candidate files in the various file repositories 104A-104F and/or determine which of the candidate files should be scanned to identify possible target files, such as EUCTs. In some embodiments, for example, the target file scan system 102 may include one or more computing devices specially configured to identify a reduced set of candidate files for scanning utilizing the improved methodologies described herein.

It should be appreciated that, in some embodiments, the target file scan system 102 is controlled, operated, and/or otherwise owned by the same entity that controls, operates, and/or otherwise owns the data system 104. In other embodiments, the target file scan system 102 is controlled, operated, and/or otherwise owned by a different entity from the data system 104. For example, in some embodiments, the target file scan system 102 provides a cloud service for scanning external data systems to which it is granted access (e.g., as a software-as-a-service platform) by third-party entities controlling such external data systems.

In some embodiments, the target file scan system 102 performs the improved scanning functionality described herein at particular times. For example, in some embodiments, the target file scan system 102 initiates scanning of one or more file repositories of the data system 104 at predetermined intervals (e.g., daily, weekly, quarterly, and/or the like). In other embodiments, the target file scan system 102 initiates scanning of one or more of the file repositories of the data system 104 in response to user engagement via the client device 106 requesting or otherwise initiating such a scan. In yet other embodiments, the target file scan system 102 performs one or more determinations and initiates such scanning of one or more file repositories of the data system 104 in response to such determinations. For example, the target file scan system 102 may determine that a threshold number of file updates, saves, and/or accesses have been performed, and initiate the scan as described herein upon such determinations.

The communications network 108 comprises any combination of computing devices embodying a public, private, and/or hybrid computing network over a particular range. In some embodiments, the communication network 108 is embodied by one or more network access points, relays, base stations, data transmission devices, cellular communication towers, and/or other communication devices. In some embodiments, the communications network 108 includes any number of non-user computing devices facilitating access to and/or embodying a public network, such as the Internet. Additionally or alternatively, in some embodiments, the communication network 108 includes one or more computing devices of a user's local network, for example one or more network access point(s) such as a modem and/or router that enable access to a public, private, or hybrid network of computing devices. It should be appreciated that communications network 108 may be accessible via any of a myriad of communication mechanisms and/or protocols, including without limitation a wired connection, a Wi-Fi connection, a cellular connection, Bluetooth, and/or the like.

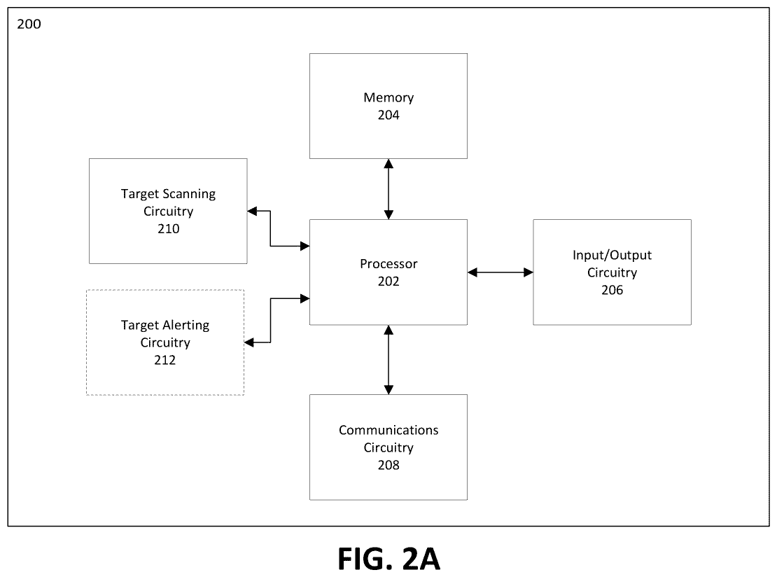

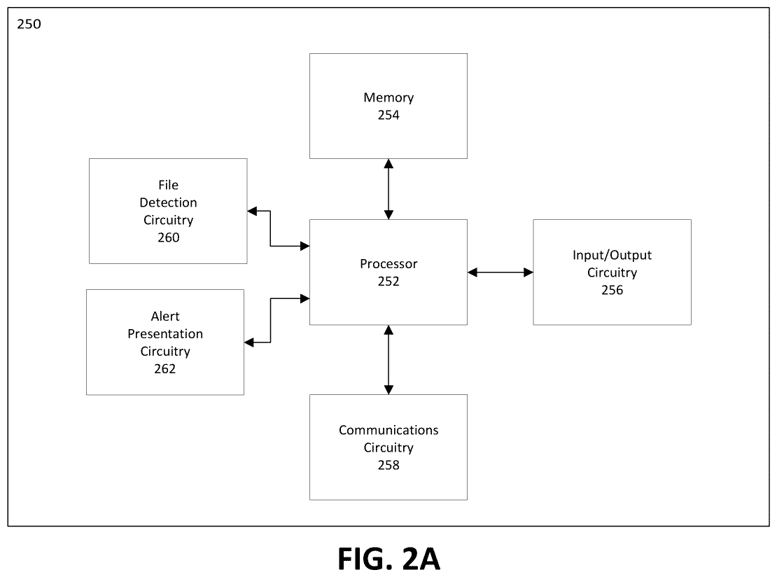

FIG. 2A illustrates a block diagram of an example targeted file scanning apparatus that may be specially configured in accordance with an example embodiment of the present disclosure. In some embodiments, the target file scan system 102 is embodied by one or more computing systems, such as the targeted file scanning apparatus 200 as depicted and described in FIG. 2A. The targeted file scanning apparatus 200 includes processor 202, memory 204, input/output circuitry 206, communications circuitry 208, target scanning circuitry 210, and/or optionally target alerting circuitry 212. The targeted file scanning apparatus 200 may be configured, using one or more of the sets of circuitry 202, 204, 206, 208, 210, and/or 212, to execute the operations described herein.

Although components are described with respect to functional limitations, it should be understood that the particular implementations necessarily include the user of particular computing hardware. It should also be understood that certain of the components described herein may include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the targeted file scanning apparatus 200 may provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) may be in communication with the memory 204 via a bus for passing information among components of the targeted file scanning apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the targeted file scanning apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” may be understood to include a single core processor, a multi-core processor, multiple processors internal to the targeted file scanning apparatus 200, and/or one or more remote or “cloud” processor(s) external to the targeted file scanning apparatus 200.

In an example embodiment, the processor 202 may be configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions may specifically configure the processor 202 to perform the algorithms embodied by the specific operations described herein when the instructions are executed.

As one particular example, the processor 202 may be configured to perform various operations associated with improved target file scanning functionality, for example as described with respect to the target file scan system 102 and/or as described further herein. In some embodiments, the processor 202 includes hardware, software, firmware, and/or a combination thereof, that identifies a plurality of candidate data files associated with one or more file repositories. Additionally or alternatively, in some embodiments, the processor 202 includes hardware, software, firmware, and/or a combination thereof, that determines a reduced set of candidate data files from a plurality of candidate files, for example by applying a hierarchy of scan criteria to the plurality of candidate files. Additionally or alternatively, in some embodiments, the processor 202 includes hardware, software, firmware, and/or a combination thereof, that outputs the reduced set of candidate data files, for example for further processing or for causing rendering of one or more associated user interfaces. Additionally or alternatively, in some embodiments, the processor 202 includes hardware, software, firmware, and/or a combination thereof, that causes rendering of scan configuration interface(s) for configuring aspects of improved target file scanning functionality as described herein, for example configuring one or more individual scan criteria, the hierarchy of scan criteria, target file repositories that are scanned, and/or the like. Additionally or alternatively, in some embodiments, the processor 202 includes hardware, software, firmware, and/or a combination thereof, that determine and/or otherwise identify one or more candidate data files are determined to comprise or embody a high target probability file (e.g., likely to include or embody a target file embodying an EUCT), and assign the corresponding file(s) to one or more target file review user accounts. Additionally or alternatively, in some embodiments, the processor 202 includes hardware, software, firmware, and/or a combination thereof, that enables a target file review user account to access the assigned files and/or to mark any such candidate file(s) as possibly including a target file or mark any such candidate file(s) as not including or embodying a target file, such as an EUCT.

In some embodiments, the targeted file scanning apparatus 200 includes input/output circuitry 206 that may, in turn, be in communication with processor 202 to provide output to the user and, in some embodiments, to receive an indication of a user input. The input/output circuitry 206 may comprise one or more user interface(s) and may include a display that may comprise the interface(s) rendered as a web user interface, an application user interface, a user device, a backend system, or the like. In some embodiments, the input/output circuitry 206 may also include a keyboard, a mouse, a joystick, a touch screen, touch areas, soft keys, a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

The communications circuitry 208 may be any means such as a device or circuitry embodied in either hardware or a combination of hardware and software that is configured to receive and/or transmit data from/to a network and/or any other device, circuitry, or module in communication with the targeted file scanning apparatus 200. In this regard, the communications circuitry 208 may include, for example, a network interface for enabling communications with a wired or wireless communication network. For example, the communications circuitry 208 may include one or more network interface card(s), antenna(s), bus(es), switch(es), router(s), modem(s), and supporting hardware, firmware, and/or software, or any other device suitable for enabling communications via one or more communication network(s). Additionally or alternatively, the communications circuitry 208 may include circuitry for interacting with the antenna(s) and/or other hardware or software to cause transmission of signals via the antenna(s) or to handle receipt of signals received via the antenna(s).

The target scanning circuitry 210 includes hardware, software, firmware, and/or a combination thereof, configured to support various functionality associated with identifying a reduced set of candidate files to be scanned as a target file, and/or performing such a scan for target files such as EUCTs. For example, in some embodiments, the target scanning circuitry 210 includes hardware, software, firmware, and/or a combination thereof, configured to identify a plurality of candidate data files associated with one or more file repositories. Additionally or alternatively, in some embodiments, the target scanning circuitry 210 includes hardware, software, firmware, and/or a combination thereof, configured to determine, rom the plurality of candidate files, a reduced set of candidate data files by applying one or more scan criteria. For example, in some embodiments, the target scanning circuitry 210 includes hardware, software, firmware, and/or a combination thereof, that applies a hierarchy of scan criteria to the plurality of data files to determine the reduced set of candidate data files from said plurality. Additionally or alternatively, in some embodiments, the target scanning circuitry 210 includes hardware, software, firmware, and/or a combination thereof, configured to output the reduced set of candidate data files.

Additionally or alternatively, in some embodiments, the target scanning circuitry 210 includes hardware, software, firmware, and/or a combination thereof, configured to generate a target likelihood score for each candidate data file in the reduced set of candidate data files, where the target likelihood score represents a probability the candidate data object comprises or embodies a target file such as an EUCT. Additionally or alternatively, in some embodiments, the target scanning circuitry 210 includes hardware, software, firmware, and/or a combination thereof, configured to determine the reduced set of candidate data files comprises at least one high target probability file based on at least the target likelihood score for each candidate file in the reduced set of candidate data files. Additionally or alternatively, in some embodiments, the target scanning circuitry 210 includes hardware, software, firmware, and/or a combination thereof, configured to assign each of the at least one high target probability files to a target file review user account. Additionally or alternatively, in some embodiments, the target scanning circuitry 210 includes hardware, software, firmware, and/or a combination thereof, configured to enable a target file review user account to access and/or mark as a target file or not as a target file (e.g., an EUCT or not as EUCT) each candidate data file assigned to the account.

Additionally or alternatively, in some embodiments, the target scanning circuitry 210 includes hardware, software, firmware, and/or a combination thereof, configured to generate one or more specially configured scan configuration interfaces for adjusting one or more configurations associated with a performed scan and/or determination of a reduced set of candidate files for scanning. For example, additionally or alternatively in some embodiments, the target scanning circuitry 210 includes hardware, software, firmware, and/or a combination thereof, configured to cause rendering of a scan configuration interface that comprises at least one hierarchy configuration element configured to, upon user interaction, configure at least a portion of the hierarchy scan criteria. For example, one or more individual scan criteria may be updated, and/or the hierarchy of scan criteria may be updated. Additionally or alternatively, in some embodiments, the target scanning circuitry 210 includes hardware, software, firmware, and/or a combination thereof, configured to cause rendering of a scan configuration interface that comprises at least one scan target configuration element configured to, upon user interaction, select one or more file repositories from a data system associated with a set of file repositories. The selected file repositories may represent selected file repositories for scanning.

In some embodiments, the target scanning circuitry 210 performs one or more of the above-mentioned actions using, in whole or in part, the communications circuitry 208, input/output circuitry 206, and/or processor 202. For example, the target scanning circuitry 210 may leverage the communications circuitry 208 to perform data receiving and/or transmitting steps, and/or may leverage the input/output circuitry 206 to perform user outputting (e.g., rendering of user interfaces) and/or user inputting steps. It should be appreciated that, in some embodiments, target scanning circuitry 210 may include a separate processor, specially configured field programmable gate array (FPGA), or a specially programmed application specific integrated circuit (ASIC).

The target alerting circuitry 212 includes hardware, software, firmware, and/or a combination thereof, configured to support various functionality for alerting a user in a circumstance where an actively accessed and/or modified file is determined to include or embody, or likely include or embody, a target file such as an EUCT. For example, in some embodiments, the target alerting circuitry 212 includes hardware, software, firmware, and/or a combination thereof, configured to detect a new version of a file accessed by a particular user account is to be saved to a file repository. Additionally or alternatively, in some embodiments, the target alerting circuitry 212 includes hardware, software, firmware, and/or a combination thereof, configured to determine the new version of the file includes or embodies, or is likely to include or embody, a target file such as an EUCT. In some embodiments, for example, the target alerting circuitry 212 includes hardware, software, firmware, and/or a combination thereof, configured to determine a new version of a file includes or embodies, or is likely to include or embody, a target file such as an EUCT based on one or more values for data properties determined based on metadata and/or content data of the new version of the file. Additionally or alternatively, in some embodiments, the target alerting circuitry 212 includes hardware, software, firmware, and/or a combination thereof, configured to output an alert associated with the determination that the new version of the file includes or embodies, or is likely to include or embody, an a target file such as an EUCT. For example, in some embodiments, the target alerting circuitry 212 includes hardware, software, firmware, and/or a combination thereof, configured to cause rendering of alert interfaces that indicate the new version of the file is determined as or likely as a target file such as an EUCT, and/or factors of the determination that provide a reason why the new version of the file was indicated as such.

In some embodiments, the target alerting circuitry 212 performs one or more of the above-mentioned actions using, in whole or in part, the communications circuitry 208, input/output circuitry 206, and/or processor 202. For example, the target alerting circuitry 212 212 may leverage the communications circuitry 208 to perform data receiving and/or transmitting steps, and/or may leverage the input/output circuitry 206 to perform user outputting (e.g., rendering of user interfaces) and/or user inputting steps. It should be appreciated that, in some embodiments, target alerting circuitry 212 may include a separate processor, specially configured field programmable gate array (FPGA), or a specially programmed application specific integrated circuit (ASIC).

It should be appreciated that, in some embodiments, one or more of the sets of circuitries 202-212 are combinable. Alternatively or additionally, in some embodiments, one or more of the modules performs some or all of the functionality described associated with another component. For example, in some embodiments, the sets of circuitry 210 and 212 are combined into a single module embodied in hardware, software, firmware, and/or a combination thereof. Similarly, in some embodiments, one or more of the sets of circuitry 210 and/or 212 is combined such that the processor 202 performs one or more of the operations described above with respect to each of these modules.

In at least one example embodiment, a client device, such as the client device 106 is embodied by one or more specially configured computing systems, such as the EUCT alerting user apparatus 250 as shown in FIG. 2B. FIG. 2B illustrates a block diagram of an example EUCT alerting user apparatus that may be specially configured in accordance with an example embodiment of the present disclosure. The EUCT alerting user apparatus 250 may include a processor 252, memory 254, input/output circuitry 256, communications circuitry 258, file detection circuitry 260, and/or alert presentation circuitry 262. Each of the components 252-262 similarly named to those depicted and described with respect to components 200-212, in some embodiments, functions in a manner similar to that as described herein with respect to the similarly named components in FIG. 2. For purposes of brevity and to avoid unnecessary overcomplication of the disclosure, repeated description of such functionality is omitted.

The file detection circuitry 260 includes hardware, software, firmware, and/or a combination thereof, configured to support functionality of the client device 106 for determining when an alert should be provided. In this regard, in some embodiments, the file detection circuitry 260 includes hardware, software, firmware, and/or a combination thereof, configured to manage and/or detect execution of an EUCT-monitored executable object. In some embodiments, the file detection circuitry 260 manages execution of the EUCT-monitored executable object with respect to a particular data file being created and/or modified via the EUCT-monitored executable object. Additionally or alternatively, in some embodiments, the file detection circuitry 260 includes hardware, software, firmware, and/or a combination thereof, configured to detect initiation of termination of an EUCT-monitored executable object. For example, in some embodiments the file detection circuitry 260 is configured to parse incoming data signals to identify that the user has requested termination of the EUCT-monitored executable object being executed, and/or termination of the EUCT-monitored executable object has otherwise been initiated. Additionally or alternatively, in some embodiments, the file detection circuitry 260 includes hardware, software, firmware, and/or a combination thereof, configured to scan file content data of a modified data file to identify whether the file content data includes one or more data portions indicating the modified data file embodies an EUCT. In some embodiments, for example, the file detection circuitry 260 is configured to scan the file content data of the modified data file to identify whether at least one calculation subprocess exists in the file content data.

In some embodiments, the file detection circuitry 260 performs one or more of the above-mentioned actions using, in whole or in part, the communications circuitry 258, input/output circuitry 256, and/or processor 252. For example, the file detection circuitry 260 may leverage the communications circuitry 258 to perform data receiving and/or transmitting steps, and/or may leverage the input/output circuitry 256 to perform user outputting (e.g., rendering of user interfaces) and/or user inputting steps. It should be appreciated that, in some embodiments, file detection circuitry 260 may include a separate processor, specially configured field programmable gate array (FPGA), or a specially programmed application specific integrated circuit (ASIC).

The alert presentation circuitry 262 includes hardware, software, firmware, and/or a combination thereof, configured to support functionality of the client device 106 for generating and/or presenting an alert to a client device. In this regard, in some embodiments, the alert presentation circuitry 262 includes hardware, software, firmware, and/or a combination thereof configured to generate an EUCT creation alert. The EUCT creation alert may be preconfigured, or in some embodiments include dynamic data portions based on the associated data file, detected data portions indicating the data file embodies an EUCT, and/or the like. Additionally or alternatively, in some embodiments, the alert presentation circuitry 262 includes hardware, software, firmware, and/or a combination thereof, configured to cause rendering of the EUCT creation alert to a client device. In some embodiments, the alert presentation circuitry 262 renders the EUCT creation alert to a display of the client device. Additionally or alternatively, in some embodiments, the alert presentation circuitry 262 is configured to transmit one or more specially configured data transmissions to the client device to cause rendering of the EUCT creation alert to the client device.

In some embodiments, the alert presentation circuitry 262 performs one or more of the above-mentioned actions using, in whole or in part, the communications circuitry 258, input/output circuitry 256, and/or processor 252. For example, the alert presentation circuitry 262 may leverage the communications circuitry 258 to perform data receiving and/or transmitting steps, and/or may leverage the input/output circuitry 256 to perform user outputting (e.g., rendering of user interfaces) and/or user inputting steps. It should be appreciated that, in some embodiments, alert presentation circuitry 262 may include a separate processor, specially configured field programmable gate array (FPGA), or a specially programmed application specific integrated circuit (ASIC).

It should be appreciated that, in some embodiments, one or more of the sets of circuitries 252-262 are combinable. Alternatively or additionally, in some embodiments, one or more of the modules performs some or all of the functionality described associated with another component. For example, in some embodiments, the sets of circuitry 260 and 262 are combined into a single module embodied in hardware, software, firmware, and/or a combination thereof. Similarly, in some embodiments, one or more of the sets of circuitry 260 and/or 262 is combined such that the processor 252 performs one or more of the operations described above with respect to each of these modules.

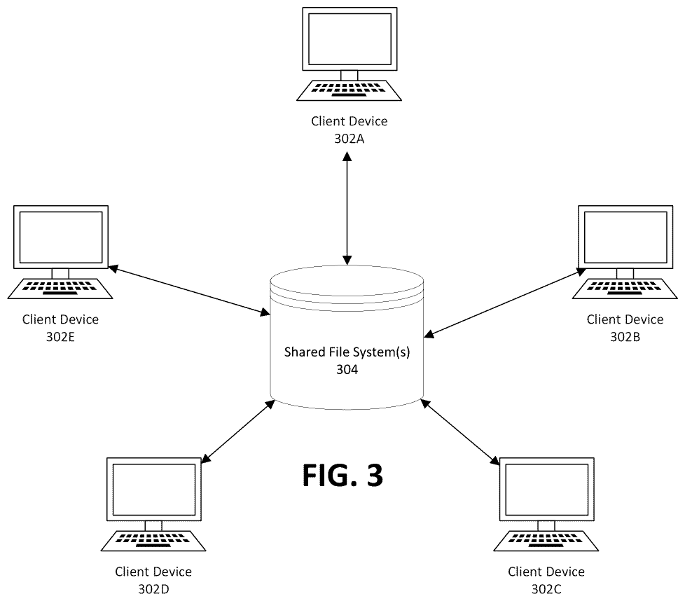

FIG. 3 illustrates a block diagram of an example data system that may include stored target files in accordance with at least some example embodiments of the present disclosure. The illustrated data system includes a plurality of client devices 302A-302E in communication with one or more shared file system(s) 304. In this regard, it should be appreciated that each of the client devices 302A-302E may be utilized to access the shared file system independently. In this regard, for example, client device 302A may be utilized by a first user to access (e.g., read out) a first file stored by the shared file system(s) 304, while the client device 302B may be utilized by a second user to access a second file stored by the shared file system(s) 304. In this regard, the client device 302A may retrieve the first file and utilize it, update it, save new versions, and/or the like to the shared file system(s) 304, and client device 302B (simultaneously or a different time) may retrieve the second file and utilize it, update it, save new versions, and/or the like to the shared file system(s) 304.

As each user interacts with the respective client devices 302A-302E, the user may utilize such client devices 302A-302E to generate and/or otherwise store a file embodying or including a target file (e.g., an EUCT) to the shared file system(s) 304. Alternatively or additionally, one or more users may utilize a client device of the client devices 302A-302E to access and utilize, and/or further modify, an existing target file (e.g., an existing EUCT) stored to the shared file system(s) 304. In this regard, the shared file system(s) 304 may end up with one or more stored files that embody or include a target file (e.g., an EUCT). Such files embodying or including a target file such as an EUCT may be stored together with and/or additional to any number of files not embodying or including a target file such as EUCTs, such that over time the total number of files stored to the shared file system(s) 304 is too significant to efficiently scan manually, or automatically in its entirety or with conventional analytical implementations (e.g., hundreds of millions, billions, or more files). To identify which files are likely to include or otherwise embody a target file such as an EUCT, the shared file system(s) 304 may be scanned utilizing the improved methodologies described herein, for example via an targeted file scanning apparatus 200 that identifies and scans a reduced set of candidate files.

Additionally or alternatively, in some embodiments, one or more of the client device(s) 302A-302E are configured such that, in a circumstance where the user of the client device attempts to save a new version of a file embodying or including a target file such as an EUCT, an alert is outputted to the user. For example, as a user of one of the client devices 302A-302E interacts with the client device to save a new file or a new version of a file, the data to be saved may be scanned to determine whether the file includes or embodies, or is likely to include or embody, a target file such as an EUCT. In this regard, the client device 302B may be specially configured to perform such functionality for generating and/or outputting the alert to the client device. In some embodiments, the client device is specially configured to perform such functionality alone, and in other embodiments the client device is specially configured to perform such functionality via communication with an targeted file scanning apparatus 200. In some embodiments, a specially configured add-in or subprogram integrated within the program for accessing, creating, and/or modifying such a file. For example, in some embodiments, an plugin or other add-in program for a word processor (and/or other type of software application) is installed to the client device that performs such target file alerting functionality.

### Example Visualizations of Example Scan Criteria of the Disclosure

Having described example systems and apparatuses in accordance with the present disclosure, example visualizations of scan criteria in accordance with the present disclosure will now be discussed. As described, in some embodiments, a reduced set of candidate files is identified for scanning to improve the overall throughput of the systems by eliminating the need to scan candidate files determined not to include or embody, or unlikely to include or embody, a target file such as an EUCT. In this regard, the various scan criteria may represent particular threshold values and/or filter values for determining whether data properties of particular candidate files indicate that such files should not be scanned (e.g., and can be removed from consideration). It should be appreciated that the scan criteria thus may function together with one another to reduce the number of candidate files to be scanned based on the values of data properties (e.g., metadata or content-based data) for each of the candidate files.

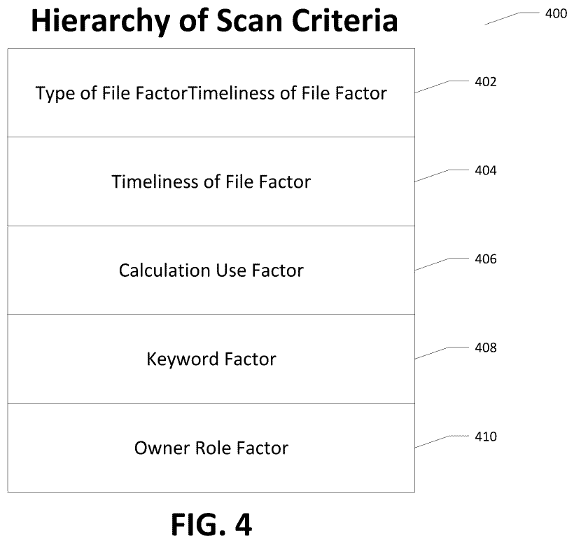

FIG. 4 illustrates a visualization of an example hierarchy of scan criteria in accordance with at least some example embodiments of the present disclosure. Specifically, FIG. 4 illustrates a hierarchy of scan criteria 400 that orders a plurality of individual scan criteria 402-410. In this regard, the example hierarchy of scan criteria 400 may define a particular set of scan criteria that narrows the objective of the scan for files likely to include or embody target files (e.g., EUCTs) based on each of the scan criteria 402-410. In this regard, applying each of the scan criteria 402-410 may remove a set of candidate files from consideration for scanning as a possible target file (e.g., a possible EUCT), thus reducing the number of required detailed scanning operations significantly while prioritizing and improving the predictive execution of the scanning operation. For example, utilizing the timeliness of file factor 402 and type of file factor 404, the set of candidate files may be reduced significantly (e.g., 99% in some circumstances), thus significantly reducing the amount of computing resources required to perform such scanning.

Applying the type of file factor 402 may first remove from consideration all candidate files not of one or more particular target file types. For example, the type of file factor 402 may embody or otherwise be associated with the particular file types to be included for consideration. In this regard, it should be appreciated that the particular data values of the type of file factor 402 may be configured automatically or by a user, for example such that the file types to be included in consideration (or in other embodiments, excluded from consideration) are embodied by the data value(s) of the type of file factor 402. In an example context, for example, a user may set particular file types associated with particular data programs known or otherwise determined by the user as likely to be associated with target files (e.g., likely to be associated with utilizing, creating, and/or owning EUCTs). Non-limiting examples of such high-risk file types include Microsoft Excel files, Microsoft Access files, SAS files, SQL files, programming language files (e.g., Python files, R files, and the like), and/or the like. The value for a data property of a particular candidate file embodying a file type for the candidate file may be compared with the type of file factor 402 to determine whether the file type for a particular candidate file satisfies the type of file factor 402. In some embodiments, the value for a file type data property of a particular candidate file is parsed from the file extension associated with the candidate file. In other embodiments, the value for a file type data property of a particular candidate file is determined from processing the data or metadata associated with the candidate file.

Applying the timeliness of file factor 404 may remove from consideration all candidate files not accessed a threshold number of times within a threshold length of time. For example, in some embodiments, the timeliness of file factor 404 is configured to remove from consideration all candidate files that have not been accessed once or more in a particular threshold length of time (e.g., the past three months). It should be appreciated that the particular data values of the timeliness of file factor 404 may be configured automatically, or by a user. For example, in some embodiments, the threshold number of times is automatically configured or configurable based on user input to meet a user's preference (e.g., threshold of once, twice, and/or the like) and/or the threshold length of time is automatically configured or configurable based on user input to meet a user's preference (e.g., 1 month, 3 months, and/or the like). The value for a data property of a particular candidate file embodying a previously accessed timestamp (and/or multiple previously accessed timestamps) may be compared with the timeliness of file factor 404 to determine whether the particular candidate file satisfies the timeliness of file factor 404.

Applying the calculation use factor 406 may remove from consideration all candidate files not defining at least one calculation factor within the candidate file. In this regard, a calculation detected in a candidate file indicates that the candidate file may more likely embody or include a target file such as an EUCT, and should not be excluded from further detailed scanning. Candidate files that do not utilize a calculation may be excluded from consideration as unlikely to embody or include a target file such as an EUCT. In some embodiments, the value for a calculation use data property of a particular candidate file may be determined by processing the content of the data file itself. In this regard, such processing may occur only for a reduced number of candidate files that have not been excluded based on one or more other scan criteria as described herein, for example as defined based on the hierarchy of scan criteria 400.

Applying the keyword factor 408 may remove from consideration one or more candidate files not including or otherwise associated with a particular count of keywords defined as likely to include or embody a target file such as an EUCT. In this regard, a set of keywords may be identified and/or otherwise determined that indicate a file is likely to include or embody a target file such as an EUCT. A value for the keyword data property associated with a particular candidate file may be determined by processing the content and/or metadata associated with the candidate data to determine how many of the determined keywords are included in or associated with the candidate file. In some embodiments the value for the keyword data property embodying the number of keywords in or associated with the candidate file may be compared with the keyword factor 408 to determine whether the number of keywords in or associated with the candidate file satisfies the value of the keyword factor 408, and the candidate file should be excluded from consideration, or in some embodiments exceeds the value of the keyword factor 408, and the candidate file should be included for consideration. In some embodiments, the value of the keyword factor 408 (e.g., which serves as a threshold number of keywords above which a candidate file is not to be excluded) may be compared to the determined data value for the keyword property associated with the candidate file to determine whether the candidate file should be excluded from consideration (or included from consideration) based on the number of keywords in or associated with the candidate file. In some embodiments, the presence of one keyword indicates the candidate file may likely embody or include a target file such as an EUCT and should not be excluded from further processing. Similarly, in some embodiments, the presence of a combination of keywords may indicate a higher likelihood that the candidate file includes or embodies a target file such as an EUCT.

Applying the owner role factor 410 may remove from consideration one or more candidate files associated with a particular owning user (e.g., an author of the candidate file) determined as associated with a particular role within a particular system or entity. For example, in some embodiments, a data value for an owner (or author) data property of a candidate file is determinable based on the metadata or data associated with the candidate file. In some such embodiments, a data value for an owner role data property of a candidate file is derivable from the data value representing the owner of the candidate file. In some embodiments, the owner is represented by the data value for the data property embodying the last modifier of a particular candidate file. For example, the data value for the owner data property (e.g., representing the owner of the candidate file) may be compared with a knowledge base including a role data value associated with such an owner, such as a business entity employee/personnel management database. The value of the owner role factor 410 may include particular roles to exclude (or in other embodiments, to include) from consideration of scanning. In some embodiments, for example, particular owner roles (e.g., those associated with managerial positions unlikely to be creating target files such as EUCTs) may be embodied in the value of the owner role factor 410, such that candidate files similarly associated with owners of such owner roles may be removed from consideration as embodying or including target files such as EUCTs. In this regard, the value of the owner role factor 410 may be compared with the data value for the owner role data property associated with a candidate file to determine whether the candidate file should be excluded (or in other embodiments, included) based on the data value for the owner role associated with the candidate file.

Owner roles additionally or alternatively be utilized to identify particular data repositories for scanning. For example, in some embodiments, a data repository owned by a user or group of users with a first owner role, such as a project management owner role, may be excluded from scanning as unlikely to include target files (e.g., EUCTs) as a part of the nature of the role. Similarly, a data repository owned by a user or group of users with a second owner role, such as a data analytics owner role, may be included for scanning as likely to include (e.g., EUCTs) as a part of the nature of the role. Such determinations and owner roles to be included for scanning may be user-configurable, predetermined, and/or otherwise determined by the apparatus 200, for example.

It should be appreciated that the example hierarchy of scan criteria 400 and individual scan criteria 402-410 are examples in one such embodiment of the present disclosure. In other embodiments, the hierarchy of scan criteria 400 may be ordered in a different manner. Alternatively or additionally, in some embodiments, alternative individual scan criteria may be included in the hierarchy of scan criteria. Accordingly, the particular hierarchy of scan criteria 400 should not limit the scope or spirit of this disclosure.

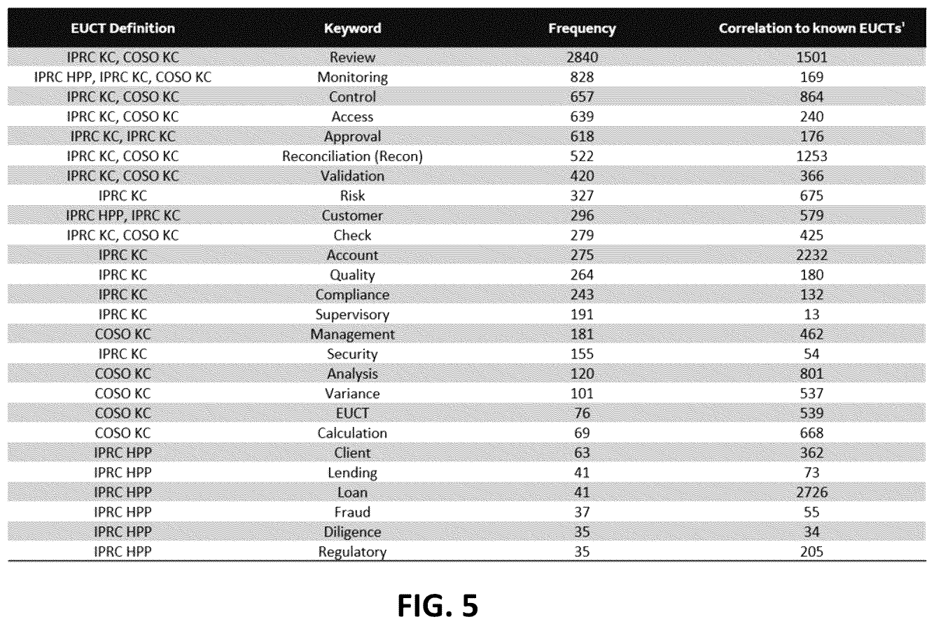

FIG. 5 illustrates a table of keyword extracted from definition criteria and associated occurrences in known target files such as EUCTs for use in keyword mining based on keyword criteria for target file identification in accordance with at least some example embodiments of the present disclosure. The table depicts aggregated keywords extracted from one or more defined criteria list(s). The table further compares the frequency of such keywords against occurrences of each keyword in the metadata and/or data (e.g., the names and/or descriptions, for example) of files known to embody or include target files such as an EUCT. In this regard, the keywords determined to appear more than a particular threshold number of times in known target files and/or target file definition keyword extraction may be utilized to perform keyword scanning of candidate files based on such keywords.

As illustrated, for example, the keyword “Review” appears 2,840 times in the list of files determined as target files (e.g., EUCTs) based on a first set of criteria (e.g., IRPC key controls and COSO key controls). Further, the keyword “Review” appears 1,501 times in the data and/or metadata (e.g., the name and/or description) of files known by the targeted file scanning apparatus 200, for example, to include or embody target files such as EUCTs. Similarly, the keyword “Reconciliation” (or similarly “Recon”) appears 522 times in the list of files determined as target files (e.g., EUCTs) from the first set of criteria. Further, the keyword “Reconciliation” or “Recon” appears 1,253 times in the data and/or metadata (e.g., the name and/or description) of files known by the targeted file scanning apparatus 200, for example, to include or embody target files such as EUCTs. In this regard, the high frequency for both values satisfies one or more relevant thresholds for utilizing as a keyword for purposes of determining the value of a keyword factor for particular keyword scan criteria, for example as described with respect to scan criteria 408. It should be appreciated that any number of keywords extracted from the target file definitions (e.g., EUCT definitions) may be included for purposes of determining a value of a keyword factor embodying a particular scan criteria.

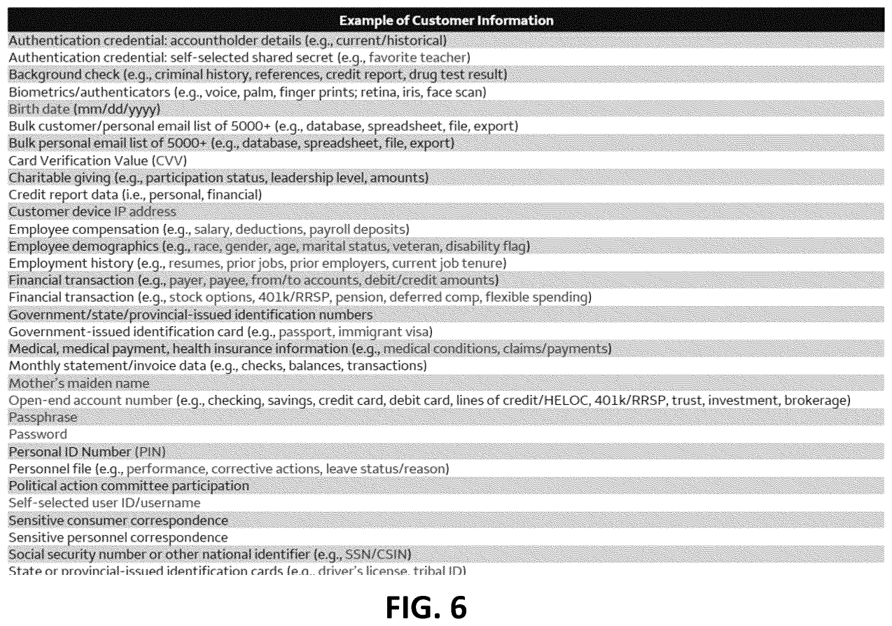

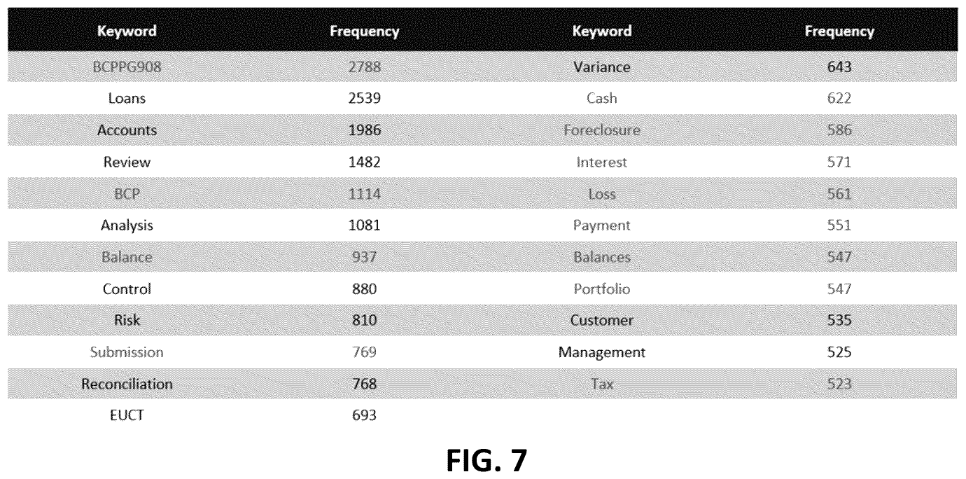

FIG. 6 illustrates a table of keywords extracted from restricted data for use in keyword mining based on keyword criteria for target file identification in accordance with at least some example embodiments of the present disclosure. In some such embodiments, keywords are extracted from one or more lists of confidential and/or otherwise restricted data values. FIG. 7 for example depicts keywords extracted from files determined to include restricted and/or confidential data representing customer information and embody or include target files such as an EUCT based on particular criteria. In some such embodiments, the keywords may be extracted and/or otherwise identified by one or more users, such as subject matter experts.

FIG. 7 illustrates a table of keywords extracted from target file information for use in keyword mining based on keyword criteria for target file identification (e.g., identifying possible EUCTs) in accordance with at least some example embodiments of the present disclosure. In some such embodiments, one or more keywords for use in determining a value for a keyword factor representing a particular scan criteria may be extracted from a known list of files embodying or including target files such as EUCTs. For example, the known list of files embodying or including target files such as EUCTs may be processed to determine a frequency for keywords that appear most throughout the entire known list of files embodying or including the target files. In some embodiments, the targeted file scanning apparatus 200 maintains the list of known target files (e.g., known EUCTs) in one or more repositories controlled by or accessible to the targeted file scanning apparatus 200 for performing such keyword mining. Alternatively or additionally, in some embodiments, the targeted file scanning apparatus 200 maintains the results of such processing (e.g., a mapping between keywords and their frequencies) in one or more repositories controlled by or accessible to the targeted file scanning apparatus 200.

As illustrated, the keywords may be extracted from particular data and/or metadata of the files known to include or embody target files such as EUCTs. For example the keywords may be extracted by processing the name and description data of the files known to include or embody target files (e.g., EUCTs) to extract the most common keywords from such data portions. The data processing of such data portions may be performed utilizing any of a myriad of known processing algorithms, for example text parsing and/or processing algorithms.

As depicted, the keyword “BCPPG908” is extracted with the highest frequency of 2,788. Subsequently, the keyword “Loans” is extracted with the second highest frequency of 2,539. In some embodiments, keywords with a particular frequency that satisfies a minimum frequency threshold may be utilized as a keyword for identifying other candidate files likely to embody or include a target file such as an EUCT. For example, in some embodiments as illustrated, a minimum frequency threshold for a keyword may embody 500 occurrences. In this regard, the presence of the extracted list of keywords in other candidate files may be determined to indicate whether the candidate file likely includes or embodies a target file such as an EUCT. The list of keywords extracted from the known files embodying or including target files such as EUCTs may be utilized to generate a data value for a keyword data property associated with a particular candidate file, for example for comparison with a keyword factor associated with a keyword scan criteria. In some embodiments, a user (e.g., a subject matter expert) may provide input embodying or otherwise identifying one or more keywords, for example in circumstances where sufficient data to perform an automatic keyword mining data process is not available.

It should be appreciated that the various methodologies described for keyword mining in FIGS. 5, 6, and 7 may each yield different keywords in some circumstances. For example, the keywords extracted utilizing the methodology described with respect to FIG. 7 includes several keywords not included in the keyword list extracted utilizing the methodology described with respect to FIG. 5. In this regard, it should be appreciated that embodiments of the present disclosure may utilize any methodology for keyword extraction to determine and/or otherwise generate the list of keywords to be utilized associated with candidate files for scanning. Alternatively or additionally, in some embodiments, multiple methodologies for keyword extraction may be utilized to determine and/or otherwise generate the list of keywords.

### Example Processes of the Disclosure

Having described example systems, apparatuses, computing environments, data visualizations, and processing component, example processes in accordance with the present disclosure will now be described. It should be appreciated that each of the flowcharts depicts an example computer-implemented process that may be performed by one or more of the apparatuses, systems, and/or devices described herein, for example utilizing one or more of the components thereof. The blocks indicating operations of each process may be arranged in any of a number of ways, as depicted and described herein. In some such embodiments, one or more blocks of any of the processes described herein occur in-between one or more blocks of another process, before one or more blocks of another process, and/or otherwise operates as a sun-process of a second process. Additionally or alternative, any of the processes may include some or all of the steps described and/or depicted, including one or more optional operational blocks in some embodiments. With regard to the flowcharts illustrated herein, one or more of the depicted blocks may be optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

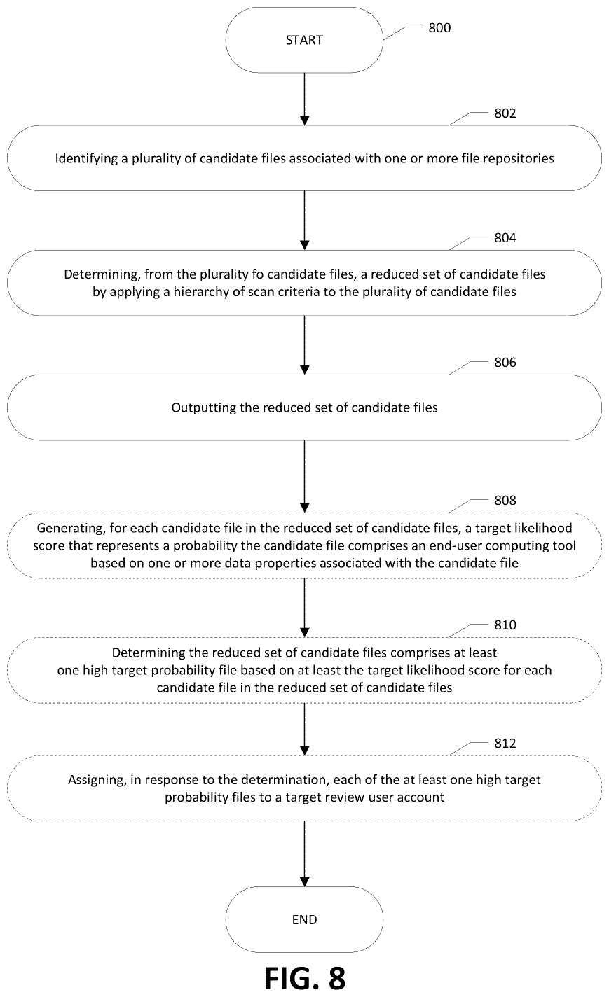

FIG. 8 illustrates a flowchart depicting example operations of a process for scanning a system of files for target files (e.g., possible EUCTs) in accordance with some example embodiments of the present disclosure. In some embodiments, the process 800 is embodied by computer program code stored on a non-transitory computer-readable medium of a computer program product configured for execution to perform the computer-implemented process described. Alternatively or additionally, in some embodiments, the process 800 is performed by one or more specially configured computing devices, such as the targeted file scanning apparatus 200 alone or in communication with one or more external devices. In this regard, in some such embodiments, the targeted file scanning apparatus 200 is specially configured by computer program instructions stored thereon, for example in the memory 204 and/or another component depicted and/or described herein, and/or otherwise accessible to the targeted file scanning apparatus 200, for performing the operations depicted and described. In some embodiments, the specially configured targeted file scanning apparatus 200 is in communication with one or more external apparatus(es), system(s), device(s), and/or the like, to perform one or more of the operations as depicted and described. For purposes of simplifying the description, the process 800 is described as performed by and from the perspective of the targeted file scanning apparatus 200.

The process 800 begins at operation 802. At operation 802, the targeted file scanning apparatus 200 includes means, such as the target scanning circuitry 210, the communications circuitry 208, the input/output circuitry 206, and/or the processor 202, to identify a plurality of candidate data files associated with one or more file repositories. For example, the targeted file scanning apparatus 200 may identify the plurality of candidate data files by identifying all files stored within the one or more file repositories, and/or portions thereof. In some embodiments, the one or more file repositories are identified automatically by the targeted file scanning apparatus 200 and/or the in other embodiments the one or more file repositories are identified based on user-selection of the file repositories. For example, the targeted file scanning apparatus 200 may configured to enable access to particular file repositories of a data system, and the targeted file scanning apparatus 200 and/or a user may select from the one or more file repositories for processing from all accessible file repositories.

At operation 804, the targeted file scanning apparatus 200 includes means, such as the target scanning circuitry 210, the communications circuitry 208, the input/output circuitry 206, and/or the processor 202, to determine, from the plurality of candidate files, a reduced set of candidate data files. In this regard, the plurality of candidate files may be reduced to the reduced set of candidate data files by removing one or more candidate files determined not likely to include and/or embody a target file, such as an EUCT. In some embodiments, one or more of the plurality of candidate files may be removed based on the values for one or more data properties associated with or derived from the candidate file.

In some embodiments, the reduced set of candidate data files is identified by applying a hierarchy of scan criteria to the plurality of candidate data files. In this regard, the hierarchy of scan criteria may include one or more scan criteria that indicates whether a candidate file should be removed from consideration based on a value for one or more data properties associated with the candidate file. For example, the hierarchy of scan criteria may include a timeliness of file factor representing a first scan criteria, such that candidate files that have not been accessed for more than a threshold length of time (e.g., based on the data value for a last accessed data property embodied in the metadata of the candidate file, for example) are removed from the plurality of candidate files and thereby removed from consideration as possibly including or embodying a target file, such as an EUCT. Similarly, the hierarchy of scan criteria may include a type of file factor representing a second scan criteria, such that candidate files that are not of a particular file type (e.g., based on a value for a file extension data property embodied in the metadata of the candidate file, for example) are removed from the plurality of candidate files and thereby removed from consideration as possibly including or embodying a target file, such as an EUCT. In some embodiments, the hierarchy of scan criteria is applied iteratively, such that a first scan criteria is utilized to reduce the plurality of candidate files to determine a preliminary reduced candidate file set. The preliminary reduced candidate file set may subsequently be further reduced by a second scan criteria, and so on for subsequent scan criteria as described herein.

At operation 806, the targeted file scanning apparatus 200 includes means, such as the target scanning circuitry 210, the communications circuitry 208, the input/output circuitry 206, and/or the processor 202, to output the reduced set of candidate data files. In some embodiments, the reduced set of candidate data files is output for further processing. For example, in some embodiments, the targeted file scanning apparatus 200 outputs the reduced set of candidate data files to initiate a detailed scanning process associated with some or all of the candidate data files from the reduced set. Alternatively or additionally, in some embodiments, the reduced set of candidate data files is output to cause rendering of information embodying or associated with the reduced set of candidate data files to be rendered via one or more user interfaces. For example, one or more user interfaces may be rendered to a client device that identifies each of the candidate files. In yet other embodiments still, the reduced set of candidate files, or a portion thereof, is output for processing via user interaction associated with one or more users, for example for manual review of one or more candidate files by a target file review user account.

In some embodiments, the targeted file scanning apparatus 200 is further configured to enable manual review of one or more candidate files by a target file review user account, for example as described with respect to operations 808-810. At optional operation 808, the targeted file scanning apparatus 200 includes means, such as the target scanning circuitry 210, the communications circuitry 208, the input/output circuitry 206, and/or the processor 202, to generate, for each candidate data file in the reduced set of candidate data files, a target likelihood score. The target likelihood score may represent a probability that the candidate data file comprises or otherwise embodies a target file such as an EUCT. The target likelihood score may be based on one or more data properties associated with the candidate data file. For example, the target likelihood score may be determined based on a number of keywords identified in the data and/or metadata of the candidate file, the file type associated with the candidate file, owner data and/or owner role(s) for owner(s) of the candidate data, and/or the like. In some embodiments, the target likelihood score is generated by a determination algorithm that weights the various data properties processed for purposes of applying the hierarchy of scan criteria, and/or calculates the factor values to be altered by each weight based on the data value for each data property as described herein. In some embodiments, the target likelihood score represents a number of scan criteria that were met, a determined complexity of the file, a determined likelihood that the owner role of the owner of the candidate file owns a target file, and/or a combination thereof.

At optional operation 810, the targeted file scanning apparatus 200 includes means, such as the target scanning circuitry 210, the communications circuitry 208, the input/output circuitry 206, and/or the processor 202, to determine the reduced set of candidate data files comprises at least one high target probability file. In some embodiments, the at least one high target probability file is/are determined based on at least the target likelihood score for each candidate data file in the reduced set of candidate data files. Each high target probability file may be determined to be associated with a target likelihood score that is sufficiently high to suggest that the candidate file includes or embodies a target file, such as an EUCT. In some embodiments, for example, the at least one high target probability file is/are determined based on the target likelihood score for the candidate file exceeding an target probability threshold. In this regard, the target probability threshold may embody a value above which a target likelihood score is determined as likely to indicate a candidate file includes or embodies a target file such as an EUCT. Alternatively or additionally, in some embodiments the at least one high target probability file is determined based on a ranked order of the reduced set of candidate data files based on the target likelihood scores for each candidate data file. For example, in some such embodiments, the candidate files associated with the top X (where X is a number set automatically by the targeted file scanning apparatus 200 and/or via user selection by a user via the targeted file scanning apparatus 200) ranked candidate files based on the target likelihood scores are determined as the at least one high target probability file. For example, in some embodiment, the at least one high target probability file includes the candidate files corresponding to the top 100 highest target likelihood scores determined as described herein.

At optional operation 812, the targeted file scanning apparatus 200 includes means, such as the target scanning circuitry 210, the communications circuitry 208, the input/output circuitry 206, and/or the processor 202, to assign each of the at least one high target probability files to a target file review user account. In some embodiments, each of the at least one high target probability files is assigned to a target file review user account in response to the determination of the at least one high target probability file from the reduced set of candidate data files. Each target file review user account may correspond to a particular user that indicates whether a particular candidate file is/includes or is not/does not include a target file such as an EUCT. In this regard, the targeted file scanning apparatus 200 may assign each of the at least one high target probability files to a random target file review user account, to a target file review user account currently assigned the least candidate files to review, and/or based on any of a myriad of other determinations. In yet other embodiments, the targeted file scanning apparatus 200 assigns at least one high target probability file based on user input selecting a particular target file review user account to which the candidate file is to be assigned. In some embodiments, a candidate file is assigned for review to a target file review user account corresponding to the owner associated with that candidate file (e.g., a last modifier of the candidate file).

Upon assigning a high target probability file to a target file review user account, the user associated with the target file review user account may indicate whether the assigned high target probability file is or includes a target file such as an EUCT. In this regard, the target file review user account may provide access to view and/or process the high target probability file, for example to determine whether the high target probability file includes or embodies a target file such as an EUCT. In circumstances where the high target probability file is determined to include or embody a target file such as an EUCT, the user may provide user input indicating such to flag or otherwise store data indicating the high target probability file embodies or includes a target file such as an EUCT. Alternatively or additionally, in a circumstance where the high target probability file is determined to not include or embody a target file (e.g., an EUCT), the user may provide user input indicating such to flag or otherwise store data indicating the high target probability data file is/includes, or is not/does not include, a target file such as an EUCT. It should be appreciated that, for candidate files that are determined to embody or include one or more target files (e.g., EUCTs), one or more procedures associated with governing and/or storing the candidate file may be initiated.

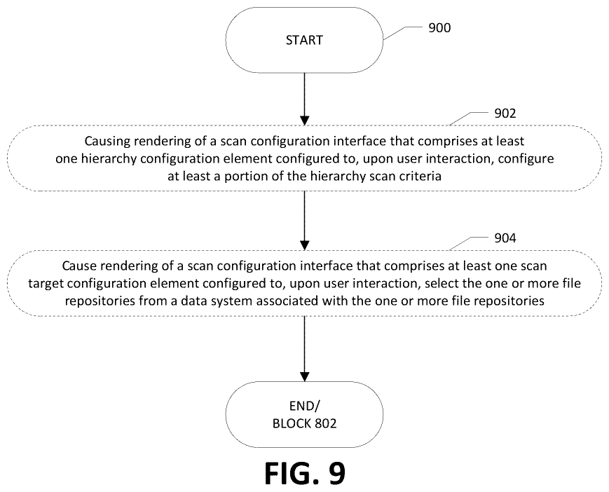

FIG. 9 illustrates a flowchart depicting example additional operations of a process for scanning a system of files for a target file (e.g., an EUCT), specifically for causing rendering of particular scan configuration interfaces in accordance with at least some example embodiments of the present disclosure. Specifically, FIG. 9 depicts an example process 900 for causing rendering of a scan configuration interface for initiating a scan operation In some embodiments, the process 900 is embodied by computer program code stored on a non-transitory computer-readable medium of a computer program product configured for execution to perform the computer-implemented process described. Alternatively or additionally, in some embodiments, the process 900 is performed by one or more specially configured computing devices, such as the targeted file scanning apparatus 200 alone or in communication with one or more external devices. In this regard, in some such embodiments, the targeted file scanning apparatus 200 is specially configured by computer program instructions stored thereon, for example in the memory 204 and/or another component depicted and/or described herein, and/or otherwise accessible to the targeted file scanning apparatus 200, for performing the operations depicted and described. In some embodiments, the specially configured targeted file scanning apparatus 200 is in communication with one or more external apparatus(es), system(s), device(s), and/or the like, to perform one or more of the operations including the various operations depicted and described herein. For purposes of simplifying the description, the process 900 is described as performed by and from the perspective of the targeted file scanning apparatus 200.

The process 900 begins at optional operation 900. In some embodiments, the process 900 begins after one or more operations of another process. Additionally or alternatively, in some embodiments, upon completion of the process 900 flow proceeds to one or more operations of another process, such as the operation 802 of the process 800 as depicted and described. In other embodiments, the flow ends upon completion of the process 900. In some embodiments, one of the operations 902 or 904 is performed. In other embodiments, both of the operations 902 and 904 are performed.

At optional operation 902, the targeted file scanning apparatus 200 includes means, such as the target scanning circuitry 210, the communications circuitry 208, the input/output circuitry 206, and/or the processor 202, to cause rendering of a scan configuration interface that comprises at least one hierarchy configuration element configured to, upon user interaction, configure at least a portion of the hierarchy scan criteria. In some embodiments, for example, the scan configuration interface enables selection and/or configuration of particular scan criteria to be utilized. For example, the hierarchy configuration element may be configured to, upon user interaction, enable the user to input data values for each scan criteria, such as where the inputted data values represent thresholds for purposes of comparison with a corresponding data value of a data property for a particular candidate file. Alternatively or additionally, in some embodiments, the hierarchy configuration element is configured to enable a user to provide user interaction for reordering scan criteria embodying the hierarchy scan criteria. For example, a user may reorder the individual scan criteria such that a first scan criteria is represented at the top of the hierarchy scan criteria, followed by a second desired scan criteria, and the like. In some embodiments, the targeted file scanning apparatus 200 causes rendering of the scan configuration interface to a display of the targeted file scanning apparatus 200. In other embodiments, the targeted file scanning apparatus 200 causes rendering of the scan configuration interface to a display of a client device (for example, associated with a particular user that initiated a scan), for example via one or more specially configured transmissions to the client device.

At optional operation 904, the targeted file scanning apparatus 200 includes means, such as the target scanning circuitry 210, the communications circuitry 208, the input/output circuitry 206, and/or the processor 202, to cause rendering of a scan configuration interface that comprises at least one scan target configuration element configured to, upon user interaction, select the one or more file repositories from a data system associated with the one or more file repositories. In this regard, the one or more file repositories from which candidate files are to be identified may be user-selected via the scan configuration interface. For example, the target configuration element may enable input of particular shard drives of the data system that are accessible for scanning. The user, via user interaction, may indicate the one or more file repositories to be scanned via user interaction with the at least one scan target configuration element of the scan configuration interface. It should be appreciated that the user may similarly remove one or more file repositories not to be considered for candidate files for scanning for target files such as EUCTs.

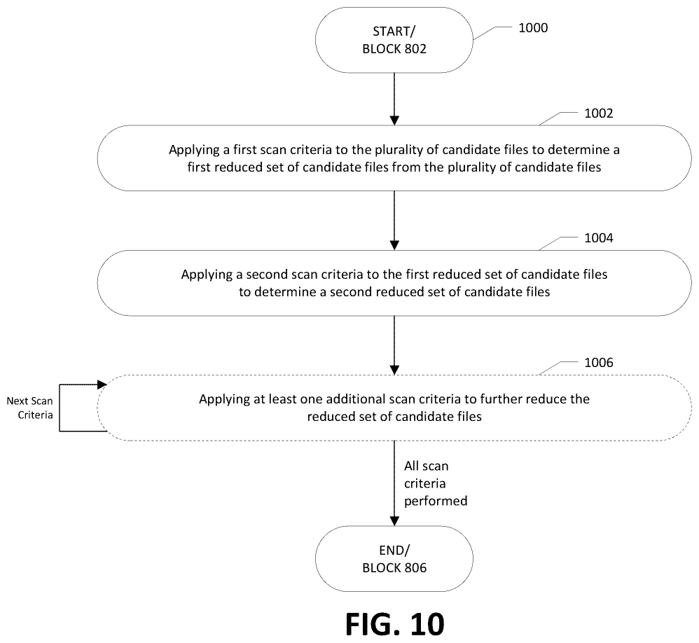

FIG. 10 illustrates a flowchart depicting example additional operations of a process for scanning a system of files for possible target files (e.g., possible EUCTs), specifically for applying a plurality of scan criteria in accordance with at least some example embodiments of the present disclosure. In some embodiments, the process 1000 is embodied by computer program code stored on a non-transitory computer-readable medium of a computer program product configured for execution to perform the computer-implemented process described. Alternatively or additionally, in some embodiments, the process 900 is performed by one or more specially configured computing devices, such as the targeted file scanning apparatus 200 alone or in communication with one or more external devices. In this regard, in some such embodiments, the targeted file scanning apparatus 200 is specially configured by computer program instructions stored thereon, for example in the memory 204 and/or another component depicted and/or described herein, and/or otherwise accessible to the targeted file scanning apparatus 200, for performing the operations depicted and described. In some embodiments, the specially configured targeted file scanning apparatus 200 is in communication with one or more external apparatus(es), system(s), device(s), and/or the like, to perform one or more of the operations including the various operations depicted and described herein. For purposes of simplifying the description, the process 900 is described as performed by and from the perspective of the targeted file scanning apparatus 200.

The process 1000 begins at operation 1000. In some embodiments, the process 1000 begins after one or more operations of another process, for example after completion of operation 802 of the process 800 as depicted and described. Additionally or alternatively, in some embodiments, upon completion of the process 1000 flow proceeds to one or more operations of another process, such as the operation 806 of the process 800 as depicted and described. In other embodiments, the flow ends upon completion of the process 1000.

At operation 1002, the targeted file scanning apparatus 200 includes means, such as the target scanning circuitry 210, the communications circuitry 208, the input/output circuitry 206, and/or the processor 202, to apply a first scan criteria to the plurality of candidate data files. The first scan criteria may be applied to the plurality of candidate data files to determine a first reduced set of candidate data files from the plurality of candidate data files. In this regard, the first scan criteria may exclude one or more candidate data files of the plurality of candidate data files from consideration for scanning for EUCTs. It should be appreciated that, in some embodiments, the first scan criteria is defined by the hierarchy of scan criteria. For example, the first scan criteria may exclude a first portion of the plurality of candidate data files from further consideration based on a comparison between the file types associated with such candidate data files and a data value for a file type factor embodying the first scan criteria.

In some embodiments, the scan criteria of the hierarchy of scan criteria are processed iteratively to continue to decrease the size of candidate files to be processed by processing the reduced set of candidate files via the next scan criteria in the hierarchy of scan criteria. In this regard, each subsequent iterative step may exclude any number of the remaining candidate files from consideration for scanning for a target file such as an EUCT. At operation 1004, the targeted file scanning apparatus 200 includes means, such as the target scanning circuitry 210, the communications circuitry 208, the input/output circuitry 206, and/or the processor 202, to apply a second scan criteria to the first reduced set of candidate data files. In this regard, the second scan criteria may exclude one or more candidate data files that remain after applying the first scan criteria. The second scan criteria may be determined based on a defined order embodied by the hierarchy of scan criteria. For example, the second scan criteria may exclude a second portion of remaining candidate files from the first reduced set of candidate files from further consideration based on a comparison between the last access datetime value for each candidate file and a data value for a timeliness of file factor embodying the second scan criteria.

Such an interactive process may continue for any number of additional scan criteria. For example, in a circumstance where an additional scan criteria of the hierarchy of scan criteria has not yet been applied, the next additional scan criteria of the hierarchy of scan criteria may be applied. At optional operation 1006, the targeted file scanning apparatus 200 includes means, such as the target scanning circuitry 210, the communications circuitry 208, the input/output circuitry 206, and/or the processor 202, to apply at least one additional scan criteria to further reduce the reduced set of candidate data files. For example, with respect to the second reduced set of candidate data files determined at operation 1004, the first additional scan criteria may be applied to further reduce this second reduced set of candidate data files and determine a third reduced set of candidate data files based on the additional scan criteria. Should another scan criteria remain unperformed, the next additional scan criteria may be applied to further reduce the third reduced set of candidate and determine a corresponding fourth reduced set of candidate data files. Such a process may continue until the hierarchy of scan criteria is completely performed, resulting in the final reduced set of candidate data files with portions removed based on each scan criteria of the hierarchy of scan criteria. The final reduced set of candidate files may subsequently be processed further, for example for outputting as described with respect to operation 806 and/or processing to perform one or more detailed scanning operations for identifying candidate files including or embodying target files such as EUCTs.

In other embodiments, multiple scan criteria are applied in parallel. For example, in some embodiments, as a candidate file is identified, each scan criteria is applied to the candidate file together. In this regard, in a circumstance where one or more scan criteria indicate the candidate file should be excluded, the candidate file may be excluded from subsequent scanning and/or other processing.

### Example Computing Environments of the Disclosure for EUCT Alerting

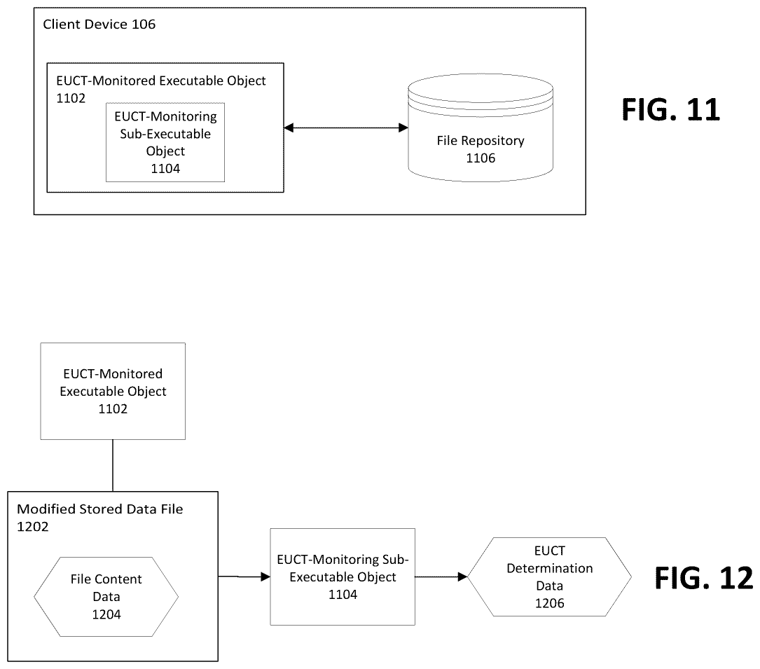

FIG. 11 illustrates a visualization of interactions between computing components in an example computing environment for EUCT alerting in accordance with at least some example embodiments of the present disclosure. the example computing environment is maintained by a client device 106, for example which may be embodied by the EUCT alerting user apparatus 250. In this regard, the computing environment may be embodied by specially-configured hardware of the EUCT alerting user apparatus 250 to provide various computing components described with respect to the depicted computing environment.

For example, as illustrated, the client device 106 embodied by the EUCT alerting user apparatus 250 includes an EUCT-monitored executable object 1102. The EUCT-monitored executable object 1102 may embody one or more software applications downloaded and/or installed to the client device 106. The EUCT-monitored executable object 1102 may provide access to one or more data files stored via and/or otherwise accessible to the client device 106, for example data files within the file repository 1106. In this regard, the client device 106 may execute the EUCT-monitored executable object 1102 to enable the user of the client device 106 to utilize the EUCT-monitored executable object 1102 to create, modify, and/or otherwise interact with such data files. As such, the client device 106 may load computer-coded instructions from a memory of the client device 106 and execute the computer-coded instructions.

In some embodiments, the EUCT-monitored executable object 1102 may be associated with a particular file type. In this regard, the EUCT-monitored executable object 1102 may be configured to interact with data files formatted according to the particular file type. The particular file type may indicate that data files created and/or otherwise associated with the EUCT-monitored executable object 1102 may embody an EUCT.

The client device 106 includes or otherwise is associated with a file repository 1106. The file repository 1106 is configured to at least store one or more data files. For example, the file repository 1106 may be configured to store data files accessible to and/or otherwise manageable via the EUCT-monitored executable object 1102. In this regard, the user of the client device 106, for example, may utilize the EUCT-monitored executable object 1102 to access a particular data file stored to the file repository 1106. The user may then utilize functionality associated with the EUCT-monitored executable object 1102 to modify the data file and/or save the modified data file to the file repository 1106. Alternatively or additionally, the user may utilize the EUCT-monitored executable object 1102 to create a new data file and store the new data file as a modified data file to the file repository 1106.

In some embodiments, the file repository 1106 comprises or is embodied by a file repository local to the client device 106. For example, in some such embodiments, the file repository 1106 may be embodied by one or more memory devices of the client device 106, and/or virtual memory devices of the client device 106. Additionally or alternatively, in some embodiments, the file repository 1106 comprises a remote file repository made available to the client device over one or more communications networks. For example, in some embodiments, the file repository 1106 is embodied by a shared file repository made available over an internal communications network with which the client device is connected.

As depicted, the EUCT-monitored executable object 1102 incorporates an EUCT-monitoring sub-executable object 1104. The EUCT-monitoring sub-executable object 1104 may embody a plug-in or other secondary data process that, upon incorporation into the EUCT-monitored executable object 1102, provides additional functionality to the EUCT-monitored executable object 1102. In some embodiments, for example, the user of the client device 106 may download and/or install the EUCT-monitoring sub-executable object 1104 to the client device 106 and incorporate it with the EUCT-monitored executable object 1102 to enable such functionality. In other embodiments, the EUCT-monitored executable object 1102 may be installed preconfigured to incorporate the EUCT-monitoring sub-executable object 1108, such that the user is not required to incorporate the EUCT-monitoring sub-executable object 1104 before use. Similarly, such preconfigured implementations improve cybersecurity by reducing the risk that users utilize the EUCT-monitored executable object 1102 without sufficient functionality for EUCT alerting as described herein.

The EUCT-monitoring sub-executable object 1104 in some embodiments is configured to perform EUCT alerting functionality, as described herein. For example, in some embodiments the EUCT monitoring sub-executable object 1104 may be configured to determine whether a modified data file embodies or is likely to embody an EUCT. In this regard, the EUCT-monitoring sub-executable object 1104 may provide one or more EUCT creation alert(s) in response to the file content data for data files accessed, modified, and/or created by the user via the EUCT-monitored executable object 1102.

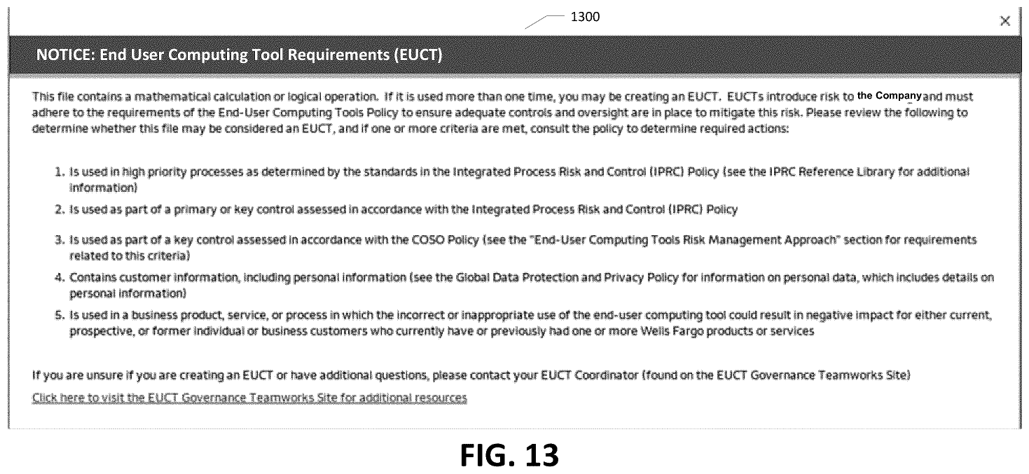

FIG. 12 illustrates a visualization of data interactions between computing components in an example computing environment for EUCT alerting in accordance with at least some example embodiments of the present disclosure. Specifically, the computing environment includes data managed and/or processed by the EUCT-monitored executable object 1102 and/or EUCT-monitoring sub-executable object 1104 as depicted and described with respect to FIG. 11. In this regard, the particular data interactions between the computing components as depicted and described may enable the EUCT alerting functionality as described herein.

As illustrated, a modified data file 1202 is accessed via the EUCT-monitored executable object 1102. In this regard, the EUCT-monitored executable object 1102 accesses the modified data file 1202 to enable creation and/or modification of the modified data file 1202 via the EUCT-monitored executable object 1102. Specifically, as illustrated, the modified data file 1202 comprises file content data 1204. The file content data may be updated, deleted, added to, and/or other modified via the EUCT-monitored executable object 1102. In one example context, for example, the modified data file 1202 embodies a spreadsheet file comprising file content data 1204 embodying cell content data, subprocesses (e.g., calculation sub-processes), and/or the like. In another example context, the modified data file 1202 embodies a localized database comprising file content data 1204 embodying user-created database queries and/or calculation subprocesses associated with the data in the database.

The user may utilize the EUCT-monitored executable object 1102 to update the file content data 1204 of the modified data file 1202 in any of a myriad of ways. In some embodiments, for example, the user may freely update the file content data 1204 to change various data values, include new data, and/or the like. Alternatively or additionally, in some embodiments, the user may update the file content data 1204 to include one or more calculation subprocesses, for example which takes as input one or more other data values (e.g., data values internal to the file content data 1204 and/or external to such data, and/or entirely external from the EUCT monitored executable object 1102) to produce one or more corresponding output values. It should be appreciated that the file content data 1204 may be formatted in a particular manner such that it is interpretable, for example via the EUCT-monitoring sub-executable object 1104, to determine whether such data embodies or likely embodies an EUCT.

The modified data file 1202 may be scanned by the EUCT-monitoring sub-executable object 1104 to generate EUCT determination data 1206. In this regard, the EUCT-monitoring sub-executable object 1104 may scan and/or otherwise process the file content data 1204 to determine whether one or more data portion(s) that indicate a data file embodies an EUCT exist in the file content data 1204. The EUCT-monitoring sub-executable object 1104 may generate EUCT determination data 1206 indicating whether the modified data file 1202 embodies an EUCT based on the scanning and/or processing of the file content data 1204. It should be appreciated that the parameters indicating whether the modified data file 1202 embodies or likely embodies an EUCT may differ based on particular defined parameters for each organization, user, and/or the like.

For example, the EUCT-monitoring sub-executable object 1104 may scan the file content data 1204 to determine whether the file content data 1204 includes one or more data portion(s) embodying at least one calculation subprocess. In a circumstance where a calculation subprocess does not exist within the file content data 1204, the EUCT determination data 1204 may be generated indicating that the modified data file 1202 does not likely embody an EUCT. In a circumstance where a calculation subprocess exists, the EUCT determination data 1204 may be generated indicating that the modified data file 1202 likely embodies an EUCT. In some such circumstances, the EUCT monitoring sub-executable 1104 may initiate one or more processes in response to the EUCT determination data 1206 indicating the modified data file 1202 is likely an EUCT. For example, in some embodiments, the EUCT-monitoring sub-executable object 1104 generates and/or causes rendering of an EUCT creation alert to a client device in response to the EUCT determination data 1206 indicating the modified data file 1202 is likely an EUCT.

The EUCT-monitoring sub-executable object 1104 may scan and/or otherwise process the modified data file 1202 to determine whether it embodies an EUCT at one or more defined times and/or upon initiation of a particular triggering event. For example, in some embodiments, the EUCT-monitoring sub-executable object 1104 is configured to detect a file storage event via the EUCT-monitored executable object 1102, and initiate scanning in response to the file storage event. The file storage event may represent initiation of the newly stored data object to a particular file repository, such as the file repository 1106 as depicted and described with respect to FIG. 11. In some embodiments, the file storage event may be initiated upon user interaction with “save as” functionality of the EUCT-monitored executable object 1102. Alternatively or additionally, in some embodiments, the EUCT-monitoring sub-executable object 1104 is configured to detect initiation of termination of the EUCT-monitored executable object, and initiate scanning in response to said initiation of termination. In some embodiments, the initiation of termination may be initiated upon user input to close the EUCT-monitored executable object 1102, or upon user input to power off or otherwise terminate operation of the client device itself.

### Example Interfaces of the Disclosure For EUCT Alerting

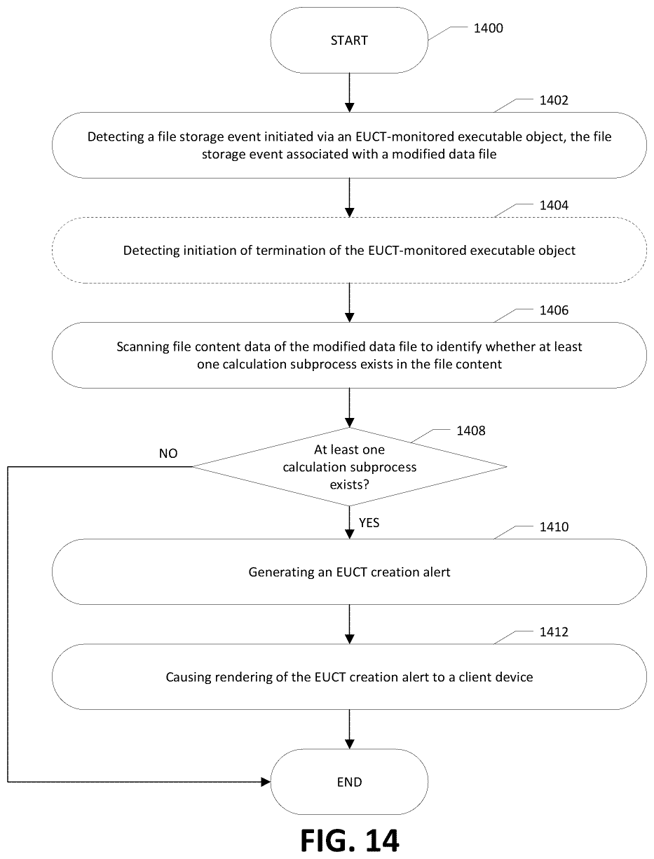

FIG. 13 illustrates an example user interface representing an EUCT creation alert in accordance with at least some example embodiments of the present disclosure. Specifically, FIG. 13 depicts an example graphical user interface representing an EUCT creation alert 1300. The EUCT creation alert 1300 may be rendered via a client device in response to a determination that a corresponding modified data file embodies an EUCT. In this regard, the EUCT creation alert 1300 may be rendered to a display of the client device in real-time for viewing and/or interaction via the user of the client device.

The EUCT creation alert 1300 includes various information regarding the determination of the corresponding modified data file as an EUCT. In particular, the EUCT creation alert 1300 includes information indicating the parameters that indicate the modified data file embodies an EUCT, in particular that at least one calculation sub-process was detected for example. In this regard, such information from the EUCT creation alert 1300 may be utilized to determine whether the met parameters truly indicate the data file embodies an EUCT, and/or may be utilized to remedy the file to remove the data portions that make the data file an EUCT.

Additionally or alternatively, in some embodiments, the EUCT creation alert 1300 comprises data indicating retention policy information associated with the modified data file. For example, such retention policy data may indicate necessary storage steps that must be performed for maintenance of EUCTs. Additionally or alternatively, the retention policy information may include necessary steps for the user to perform for the data file embodying the EUCT to be maintained in a manner that satisfies the policy. Additionally or alternatively still, the retention policy information may include user information, contact information, and/or the like, corresponding to data administrators and/or other users relevant for contacting regarding the retention policy for such EUCTs.

In some embodiments, the EUCT creation alert indicates the potential creation of an EUCT to the user. Additionally or alternatively, in some embodiments, the EUCT creation alert may include instruction data (e.g., text data, image data, other audio/visual data, and/or the like) to assist in disposition of the EUCT. For example, such instruction data may indicate steps required according to one or more applicable retention policies for storage of a file indicated as an EUCT.

It should be appreciated that, in other embodiments, the EUCT creation alert 1300 may include any of a myriad of other information. For example, in some embodiments, the EUCT creation alert 1300 may include user-instructions for removing the data portions necessary to ensure the modified data file does not embody an EUCT. Alternatively or additionally, in some embodiments, the EUCT creation alert 1300 includes one or more particular images, for example indicating the organization whose policy governs retention of the modified data file (or particular sub-unit thereof), and/or the like.

The EUCT creation alert may be rendered via an EUCT-monitoring sub-executable object together with an EUCT-monitored executable object to a client device. For example, in some embodiments, the EUCT-monitoring sub-executable object initiates rendering of the EUCT creation alert as a user interface rendered within the EUCT-monitored executable object. Additionally or alternatively, in some embodiments, the EUCT creation alert is rendered in a popup window separate to a primary user interface of the EUCT-monitored executable object 1102. For example, in circumstance where the EUCT-monitored executable object embodies an software application executed on a client device having a primary interface for interacting with data associated with the EUCT-monitored executable object (e.g., a data processing software application), the EUCT creation alert may be generated and output above the primary interface, and/or may disable interaction via the primary interface until the user interacts with the EUCT creation alert, such as by confirming existence of the EUCT creation alert and/or otherwise dismissing the EUCT creation alert. Additionally or alternatively still, in some embodiments, the EUCT creation alert is rendered via one or more external mechanisms, such as via a push notification, email message, and/or other interface rendered via a third-party application or process executing on the client device.

### Example Processes of the Disclosure For EUCT Alerting

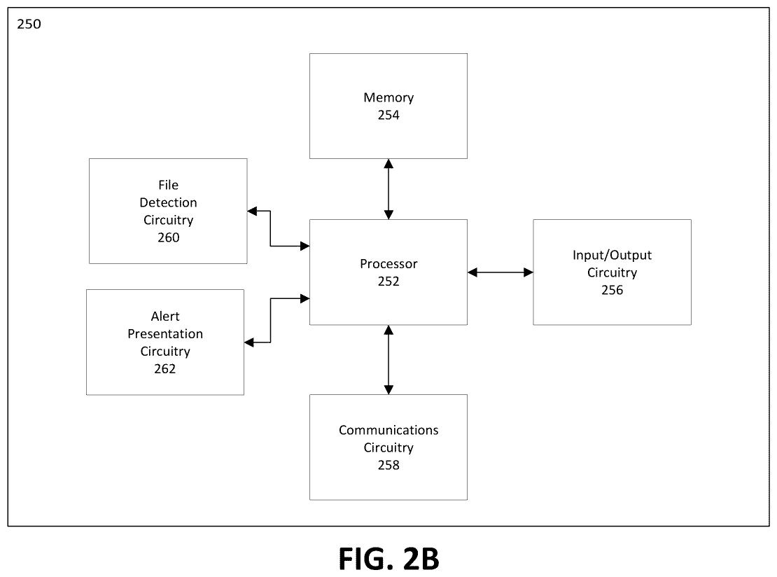

FIG. 14 illustrates a flowchart depicting example operations of a process for EUCT alerting in accordance with at least some example embodiments of the present disclosure. In some embodiments, the process 1400 is embodied by computer program code stored on a non-transitory computer-readable storage medium of a computer program product configured for execution to perform the computer-implemented process described. Additionally or alternatively, in some embodiments, the process 1400 is performed by one or more specially configured computing devices, such as the EUCT alerting user apparatus 250 alone or in combination with one or more external devices, for example the targeted file scanning apparatus 200. In this regard, in some such embodiments, the EUCT alerting user apparatus 250 is specially configured by computer program instructions stored thereon, for example in the memory 254 and/or another component depicted and described herein, and/or otherwise accessible to the EUCT alerting user apparatus 250, for performing the operations as depicted and described. In some embodiments, the specially configured EUCT alerting user apparatus 250 is in communication with one or more external apparatus(es), system(s), device(s), and/or the like, to perform one or more of the operations as depicted and described. For purposes of simplifying the description, the process 1400 is described as performed by and from the perspective of the EUCT alerting user apparatus 250.

The process 1400 begins at operation 1402. At operation 1402, the EUCT alerting user apparatus 250 includes means, such as the file detection circuitry 260, alert presentation circuitry 262, communications circuitry 258, input/output circuitry 256, processor 252, and/or the like, or a combination thereof, to detect a file storage event initiated via an EUCT-monitored executable object. The file storage event is associated with a modified data file. In this regard, the EUCT alerting user apparatus 250 may detect the file storage event upon initiation by the user of a request to save the modified data file to a particular file repository. In some embodiments, the EUCT alerting user apparatus 250 detects the file storage event via an EUCT-monitoring sub-executable object executing via the EUCT alerting user apparatus 250. For example, the EUCT-monitoring sub-executable object may be incorporated into the EUCT-monitored executable object to provide EUCT monitoring and alerting functionality as described herein. The EUCT-monitored executable object may be automatically initiated together with initiation of the file storage event, and/or in other embodiments may be consistently monitoring for the file storage event to initiate scanning in response to said file storage event.

In some embodiments, the file storage event represents saving of the modified data file to a particular file repository, for example via use of the “save as” functionality of the EUCT-monitored executable object. In some embodiments, the file storage event comprises a new file saving event. For example, the user may create a new data file via interaction with the EUCT-monitored executable object, and save the new file to a file repository where the data file had not yet been saved. Alternatively or additionally, the user may save a new copy of a data file to a new file repository, for example. Alternatively or additionally, in some embodiments, the file storage event comprises a file modification event. For example, the user may utilize the EUCT-monitored executable object to update the file content data of a particular data file, and save the updated version of the data file as the modified data file. It should be appreciated that the updated version embodied by the modified data file may be stored to the same file repository or a different file repository than the original version of the data file.

At optional operation 1404, the EUCT alerting user apparatus 250 includes means, such as the file detection circuitry 260, alert presentation circuitry 262, communications circuitry 258, input/output circuitry 256, processor 252, and/or the like, or a combination thereof, to detect initiation of termination of the EUCT-monitored executable object. In some embodiments, such termination may be initiated by a user, for example in response to attempting to close or otherwise cease execution of the EUCT-monitored executable object. Alternatively or additionally, in some embodiments, the termination is detected in response to automatically initiated terminations of the EUCT-monitored execution object, for example in response to a user beginning shutdown and/or powering off the EUCT alerting user apparatus 250. It should be appreciated that, in some circumstances, the EUCT-monitored executable object is terminated in conjunction with an initiated file storage event. In some embodiments, the EUCT alerting user apparatus 250 detects initiation of termination of the EUCT-monitored executable object via an EUCT-monitoring sub-executable object executing via the EUCT alerting user apparatus 250.

At optional operation 1406, the EUCT alerting user apparatus 250 includes means, such as the file detection circuitry 260, alert presentation circuitry 262, communications circuitry 258, input/output circuitry 256, processor 252, and/or the like, or a combination thereof, to scan file content data of the modified data file. The file content data may be scanned to determine whether one or more data potions indicating the modified data file embodies an EUCT exist within the file content data. For example, in one such example context, the EUCT alerting user apparatus 250 is configured to scan the file content data to identify whether at least one calculation subprocess exists in the file content, where the at least one calculation subprocess is embodied by at least one data portion indicating the modified data file embodies an EUCT. In some embodiments, the EUCT alerting user apparatus 250 scans the file content data of the modified data file via an EUCT-monitoring sub-executable object executing via the EUCT alerting user apparatus 250.

At operation 1408, the EUCT alerting user apparatus 250 includes means, such as the file detection circuitry 260, alert presentation circuitry 262, communications circuitry 258, input/output circuitry 256, processor 252, and/or the like, or a combination thereof, to determine whether the one or more data portions indicating the modified data file embodies an EUCT exists within the file content data of the modified data file, for example based on the scan of the file content data. In the particular example context depicted, the EUCT alerting user apparatus 250 determines whether at least one calculation subprocess exists in the file content data of the modified data file based on the scan. In a circumstance where at least one calculation subprocess does not exist, the modified data file is determined to not embody or likely not embody an EUCT, and the flow ends. In a circumstance where at least one calculation subprocess exists, the modified data file is determined to embody or likely embody an EUCT, and flow proceeds to operation 1410. In some embodiments, the EUCT alerting user apparatus 250 determines whether at least one calculation subprocess exists (or whether another data portion indicating the modified data file embodies an EUCT exists) via an EUCT-monitoring sub-executable object executing via the EUCT alerting user apparatus 250.

At operation 1410, the EUCT alerting user apparatus 250 includes means, such as the file detection circuitry 260, alert presentation circuitry 262, communications circuitry 258, input/output circuitry 256, processor 252, and/or the like, or a combination thereof, to generate an EUCT creation alert. In some embodiments, the EUCT creation alert is preconfigured to include particular static data, for example to include static information regarding EUCTs and/or retention of data files embodying an EUCT. Alternatively or additionally, in some embodiments, the EUCT creation alert is generated to include one or more dynamic data values. For example, in some embodiments, the EUCT creation alert indicates the data portions that were utilized to determine the newly stored file embodies an EUCT. Alternatively or additionally, in some embodiments, the EUCT creation alert is generated to include information specific to the retention of the modified data file, for example based on the file type of the modified data file, the file repository to which the modified data file was stored, and/or the like. In some embodiments, the EUCT alerting user apparatus 250 generates the EUCT creation alert via an EUCT-monitoring sub-executable object executing via the EUCT alerting user apparatus 250.

At operation 1412, the EUCT alerting user apparatus 250 includes means, such as the file detection circuitry 260, alert presentation circuitry 262, communications circuitry 258, input/output circuitry 256, processor 252, and/or the like, or a combination thereof, to cause rendering of the EUCT creation alert to a client device. In some embodiments, the EUCT alerting user apparatus 250 embodies the client device. For example, in some embodiments, the EUCT alerting user apparatus 250 causes rendering of the EUCT creation alert to a display viewable by a user of the EUCT alerting user apparatus 250. In some embodiments, alternatively or additionally, the EUCT alerting user apparatus 250 causes rendering of the EUCT creation alert via one or more specially configured transmissions to the client device, for example a remote client device and/or display. In some such embodiments, for example, the transmission may be specially configured to include data representing the EUCT creation alert to render. In some embodiments, the EUCT alerting user apparatus 250 causes rendering of the EUCT creation alert via an EUCT-monitoring sub-executable object executing via the EUCT alerting user apparatus 250. In some such embodiments, the EUCT-monitoring sub-executable object may initiate one or more user interfaces including or embodying the EUCT creation alert. Alternatively or additionally, in some embodiments, the EUCT-monitoring sub-executable object communicates with the EUCT-monitored executable object to cause the EUCT-monitored executable object to render a user interface comprising or embodying the EUCT creation alert.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. An apparatus for improved scanning for target files, the apparatus comprising at least one processor and at least one non-transitory memory including computer-coded instructions thereon, the computer-coded instructions, with the at least one processor, configure the apparatus to:
identify a plurality of candidate data files associated with one or more file repositories;
identify a plurality of scan criteria wherein each scan criteria is based on a data file property;
determine a hierarchy of the plurality of scan criteria, the hierarchy ordering the plurality of scan criteria based on likelihoods of scan criteria to determine whether a candidate data file of the plurality of candidate data files has a target file type, wherein a first scan criteria in a first hierarchy position of the hierarchy of the plurality of scan criteria has a highest likelihood;
display a configuration interface of the hierarchy of the plurality of scan criteria to a user;
receive input from the user that comprises a configuration of a hierarchy element of the hierarchy of the plurality of scan criteria, wherein, upon user interaction, the configuration interface is configured to change at least a portion of the hierarchy of scan criteria, wherein changing at least a portion of the hierarchy of scan criteria includes updating one or more scan criteria of the plurality of scan criteria and modifying the order of the hierarchy of the plurality of scan criteria;
apply the first scan criteria in the first hierarchy position of the hierarchy of the plurality of scan criteria to the plurality of candidate data files to determine a first reduced set of candidate data files, wherein each candidate data file of the first reduced set of candidate data files is determined as likely having the target file type by the first scan criteria in the first hierarchy position;
apply a second scan criteria in a second hierarchy position of the hierarchy of the plurality of scan criteria to the first reduced set of candidate data files to determine a second reduced set of candidate data files wherein each candidate data file of the second reduced set of candidate data files is determined as likely having the target file type by the second scan criteria in the second hierarchy position and wherein the second scan criteria is different from the first scan criteria; and
output the second reduced set of candidate data files.

2. The apparatus of claim 1, the apparatus further configured to:
generate, using a determination algorithm, for each candidate data file in the second reduced set of candidate data files, a target likelihood score that represents a probability the candidate data file is the target file based on one or more data file properties associated with the candidate data file;
determine the second reduced set of candidate data files comprises a high target probability file based on at least the target likelihood score for each candidate data file in the second reduced set of candidate data files; and
assign, in response to the determination, the high target probability file to a target file review user account.

3. (canceled)

4. The apparatus of claim 1, wherein to apply the hierarchy of scan criteria to the plurality of candidate files, the apparatus is configured to apply each scan criteria of the hierarchy of scan criteria iteratively to determine the second reduced set of candidate data files.

5. The apparatus of claim 1, wherein at least one of the scan criteria includes:
a type of file;
a calculations user;
a keyword; or
an owner role.

6. The apparatus of claim 1, wherein the one or more file repositories comprises a plurality of shared file repositories, each shared file repository of the plurality of shared file repositories separate from the other shared file repositories of the plurality of shared file repositories.

7. (canceled)

8. The apparatus of claim 1, further configured to:
display a configuration interface of the plurality of candidate data files to a user; and
receive input from the user that comprises a selection of the one or more file repositories from a data system associated with the one or more file repositories.

9. (canceled)

10. A computer-implemented method for improved scanning for target files, the computer-implemented method comprising:
identifying a plurality of candidate data files associated with one or more file repositories;
identifying a plurality of scan criteria wherein each scan criteria is based on a data file property;
determining a hierarchy of the plurality of scan criteria, the hierarchy ordering the plurality of scan criteria based on likelihoods of scan criteria to determine whether a candidate data file of the plurality of candidate data files has a target file type, wherein a first scan criteria in a first hierarchy position of the hierarchy of the plurality of scan criteria has a highest likelihood;
displaying a configuration interface of the hierarchy of the plurality of scan criteria to a user;
receiving input from the user that comprises a configuration of a hierarchy element of the hierarchy of the plurality of scan criteria, wherein, upon user interaction, the configuration interface is configured to change at least a portion of the hierarchy of scan criteria, wherein changing at least a portion of the hierarchy of scan criteria includes updating one or more scan criteria of the plurality of scan criteria and modifying the order of the hierarchy of the plurality of scan criteria;
applying the first scan criteria in the first hierarchy position of the hierarchy of the plurality of scan criteria to the plurality of candidate data files to determine a first reduced set of candidate data files, wherein each candidate data file of the first reduced set of candidate data files is determined as having the target file type by the first scan criteria in the first hierarchy position;
applying a second scan criteria in a second hierarchy position of the hierarchy of the plurality of scan criteria to the first reduced set of candidate data files to determine a second reduced set of candidate data files wherein each candidate data file of the second reduced set of candidate data files is determined as likely having the target file type by the second scan criteria in the second hierarchy position, the second scan criteria being different from the first scan criteria; and
outputting the second reduced set of candidate data files.

11. The computer-implemented method of claim 10, the computer-implemented method further comprising:
generating, for each candidate data file in the second reduced set of candidate data files, a target likelihood score that represents a probability the candidate data file is the target file based on one or more data file properties associated with the candidate data file;
determining the second reduced set of candidate data files comprises a high target probability file based on at least the target likelihood score for each candidate data file in the second reduced set of candidate data files; and
assigning, in response to the determination, the high target probability file to a target file review user account.

12. (canceled)

13. The computer-implemented method of claim 10, wherein applying the hierarchy of scan criteria to the plurality of candidate files comprises applying each scan criteria of the hierarchy of scan criteria iteratively to determine the second reduced set of candidate data files.

14. The computer-implemented method of claim 10, wherein at least one of the plurality of scan criteria includes:
a type of file;
a calculations user;
a keyword; or
an owner role.

15. The computer-implemented method of claim 10, wherein the one or more file repositories comprises a plurality of shared file repositories, each shared file repository of the plurality of shared file repositories separate from the other shared file repositories of the plurality of shared file repositories.

16. (canceled)

17. The computer-implemented method of claim 10, the computer-implemented method further comprising:
displaying a configuration interface of the plurality of candidate data files to a user; and
receiving input from the user that comprises a selection of the one or more file repositories from a data system associated with the one or more file repositories.

18. (canceled)

19. A computer program product for improved scanning for target files, the computer program product comprising at least one non-transitory computer-readable storage medium having computer program code stored thereon configured, in execution with at least one processor, for:
identifying a plurality of candidate data files associated with one or more file repositories;
identifying a plurality of scan criteria wherein each scan criteria is based on a data file property;
determining a hierarchy of the plurality of scan criteria, the hierarchy ordering the plurality of scan criteria based on likelihoods of scan criteria to determine whether a candidate data file of the plurality of candidate data files has a target file type, wherein a first scan criteria in a first hierarchy position of the hierarchy of the plurality of scan criteria has a highest likelihood;
displaying a configuration interface of the hierarchy of the plurality of scan criteria to a user;
receiving input from the user that comprises a configuration of a hierarchy element of the hierarchy of the plurality of scan criteria, wherein, upon user interaction, the configuration interface is configured to change at least a portion of the hierarchy of scan criteria, wherein changing at least a portion of the hierarchy of scan criteria includes updating one or more scan criteria of the plurality of scan criteria and modifying the order of the hierarchy of the plurality of scan criteria;
applying the first scan criteria in the first hierarchy position of the hierarchy of the plurality of scan criteria to the plurality of candidate data files to determine a first reduced set of candidate data files, wherein each candidate data file of the first reduced set of candidate data files is determined as likely having the target file type by the first scan criteria in the first hierarchy position;
applying a second scan criteria in a second hierarchy position of the hierarchy of the plurality of scan criteria to the first reduced set of candidate data files to determine a second reduced set of candidate data files wherein each candidate data file of the second reduced set of candidate data files is determined as likely having the target file type by the second scan criteria in the second hierarchy position, the second scan criteria being different from the first scan criteria; and
outputting the second reduced set of candidate data files.

20. The computer program product of claim 19, the computer program product further configured for:
generating, for each candidate data file in the second reduced set of candidate data files, a target likelihood score that represents a probability the candidate data file is the target file based on one or more data file properties associated with the candidate data file;
determining the second reduced set of candidate data files comprises a high target probability file based on at least the target likelihood score for each candidate data file in the second reduced set of candidate data files; and
assigning, in response to the determination, the high target probability file to a target file review user account.

21.-51. (canceled)

52. The apparatus of claim 1, wherein the apparatus is configured to:
determine that an accessed or modified file includes the target file, wherein an established system risk is attributed to the target file; and
output, via a client device, an alert associated with the determination that the accessed or modified file includes the target file.

53. The computer-implemented method of claim 10, the computer-implemented method further comprising:
determining that an accessed or modified file includes the target file, wherein an established system risk is attributed to the target file; and
outputting, via a client device, an alert associated with the determination that the accessed or modified file includes the target file.
